(19) United States
(12) Patent Application Publication
(10) Pub. No.: US 2026/0331620 A1
(43) Pub. Date: Oct. 22, 2026

(54) Energy storage life extension system for solar power generation

(71) Applicant: Leo Sun, Charlotte, NC (US)

(72) Inventors: Leo Sun, Charlotte, NC (US); Yueqin Cui, Luoyang (CN); Wenjun Fan, Wuhan (CN)

(21) Appl. No.: 19/377,112

(22) Filed: Nov. 3, 2025

(30) Foreign Application Priority Data
Sep. 30, 2025 (CN) 2025114285476

(51) Int. Cl. H01M 10/617; H01M 10/633; H01M 10/635; H01M 10/652; H01M 10/655; H01M 10/658; H01M 50/24; H01M 50/269

(52) U.S. Cl. CPC H01M 10/617; H01M 10/633; H01M 10/635; H01M 10/652; H01M 10/655; H01M 10/658; H01M 50/24; H01M 50/269

(57) ABSTRACT

This invention discloses an energy storage life extension system for solar power generation, comprising a battery module 101, a photovoltaic power generation unit 201, a battery management system 301, and a low-temperature life extension module 401. This invention actively maintains the battery module in a low-temperature range to extend battery life and improve the overall vehicle's life-cycle economics. While maintaining low-temperature stability, it effectively reduces energy consumption, avoiding the high energy consumption and high cost problems of traditional methods relying on heating or insulation. Therefore, this invention can significantly improve cycle life, reduce energy consumption, and promote efficient and reliable synergy between solar power generation and energy storage while ensuring battery performance, demonstrating innovation and broad application prospects.

### CROSS REFERENCE TO RELATED APPLICATIONS

This application claims priority to Chinese Patent Application No. 2025114285476, filed on Oct. 10, 2025, in China, the entire contents of which are hereby incorporated by reference.

### TECHNICAL FIELD

This invention relates to the technical field of combining photovoltaic power generation and energy storage systems, specifically an energy storage life extension system for solar power generation. It can also be applied to distributed photovoltaic power generation with energy storage, household photovoltaic energy storage systems, microgrids and islanded grids, photovoltaic+charging pile integrated systems, emergency and mobile energy storage equipment, and industrial and commercial peak shaving and valley filling, etc. It can also be extended to large-scale centralized energy storage power stations and other new energy power generation systems that require supporting energy storage.

### BACKGROUND OF THE INVENTION

With the popularization of photovoltaic power generation technology, energy storage systems have become an important support for realizing the efficient utilization of new energy sources. However, the performance of lithium batteries is severely affected by ambient temperature, especially in cold environments, where battery capacity and discharge efficiency decrease. This indirectly limits the application of photovoltaic power generation in cold regions or winter. Currently, existing energy storage systems typically use heating or insulation devices to avoid the impact of low-temperature environments on battery performance, but this obviously increases system energy consumption and cost, and is a passive coping measure aimed at performance repair rather than performance improvement.

In addition, the cycle life and safety of lithium batteries have also attracted much attention, especially in the face of challenges from emerging battery technologies such as sodium-ion batteries, making their improvement even more urgent. Therefore, extending battery life, improving low-temperature performance, and reducing energy consumption have become important directions for the improvement of energy storage system technology. The many problems existing in energy storage systems provide clear technical improvement space for this invention, and also highlight the innovative value and industrial application potential of this invention in terms of battery life extension and energy saving.

### SUMMARY OF THE INVENTION

This invention aims to solve the core problem of energy storage systems in practical application scenarios: how to significantly extend the lifespan of energy storage systems, effectively control system energy consumption, and achieve a balance between economy and safety throughout the entire life cycle. To this end, this invention proposes a disruptive concept centered on “actively embracing low temperatures and extending lifespan,” and achieves technological breakthroughs through systematic innovation.

The technical solution of this case may seem similar to traditional thermal management technology for energy storage systems at first glance, but in reality, they are completely different. Existing thermal management technology for energy storage systems only focuses on maintaining the battery at normal temperature to prevent it from overheating or overcooling. Its design philosophy is “avoiding high temperatures, avoiding low temperatures, and maintaining normal temperatures.” Under this philosophy, the energy consumption of the heat dissipation system is usually not high, and ordinary heat dissipation methods can meet the actual application requirements.

The inventors of this invention discovered through long-term systematic experiments that various types of batteries can achieve unexpected lifespan extensions under low-temperature conditions, even significantly extending them by three to four times, which is of revolutionary significance. This discovery completely overturns the existing battery thermal management concept: evolving from “avoiding high temperatures, avoiding low temperatures, and embracing room temperature” to “embracing low temperatures and seeking to extend lifespan.” The core of this invention lies in effectively utilizing experimental findings to make battery life extension the main design goal, breaking through traditional concepts.

The inventors conducted long-term, systematic experimental research on various battery types, including lithium iron phosphate and ternary materials, and tested in detail the capacity retention, discharge efficiency, and degradation rate of batteries in different temperature ranges. Experimental data shows that batteries have significantly longer cycle life when operating in low-temperature environments. This discovery overturns the traditional understanding that “low temperatures are necessarily detrimental” and reveals the key role of moderately low-temperature environments in extending the lifespan of lithium batteries. The core technology of this invention lies in scientifically establishing the positive impact of low-temperature environments on batteries based on long-term experimental data.

Based on the above experimental findings, the inventors designed the temperature control scheme for the energy storage life extension system described in this patent. By stably maintaining the battery in the low-temperature operating range, the low-temperature life extension effect is actively utilized, significantly improving the reliability and economy of the energy storage system. This invention not only breaks through the technical bottleneck of relying on heating and high-temperature management in the past, but also effectively reduces the energy consumption and operation and maintenance costs of the energy storage system through scientific low-temperature environment management, extends the actual service life of the lithium battery, and achieves unexpected technical effects and economic benefits.

To achieve this goal, the battery temperature must be reduced to a low-temperature operating range significantly lower than the “normal temperature scenario”. This is something that professionals in the field would not choose and would even try to avoid, because the low-temperature environment will cause a loss in battery capacity, and maintaining the low-temperature scenario also requires a more complex design than the “normal temperature scenario”, and will consume additional energy during operation, resulting in a triple loss. Therefore, how to control the system energy consumption under low-temperature operating conditions so that the heat dissipation system can still maintain high energy efficiency under the goal of extending lifespan is another difficult problem.

To this end, the present invention proposes an energy efficiency optimization scheme based on the low-temperature life extension module. By maintaining the battery module in the low-temperature operating range through passive heat dissipation (or other efficient heat dissipation methods), and combined with the intelligent control of the charging and discharging process by the battery management system, the system can extend battery life while avoiding unnecessary energy loss at low temperatures. This design not only achieves the effect of low-temperature life extension, but also takes into account the available capacity and power output performance, enabling the energy storage system to operate efficiently in solar power generation scenarios, thereby realizing the organic combination of low-temperature life extension and energy efficiency optimization, which constitutes the core technological innovation of the present invention.

This solution overcomes these problems through new discoveries and designs: it not only extends the lifespan but also reduces energy loss and operating costs, and achieves higher returns on investment from a life-cycle perspective. This innovative solution is particularly suitable for scenarios combining photovoltaic power generation and energy storage, utilizing the stable low-temperature environment of the photovoltaic power station location to achieve precise temperature control management of the battery, providing a new, efficient, and sustainable solution for the photovoltaic energy storage industry.

In summary, this invention not only simplifies the temperature control design of the energy storage life extension system and lowers the threshold for modification and operation and maintenance, but also provides flexible, low-cost, and efficient solutions for different application scenarios through diversified pipe materials and heat dissipation methods, demonstrating strong technological innovation and broad application prospects. The core idea of this invention is to overturn the traditional temperature control concept of “avoiding low temperatures” and actively utilize the low-temperature environment as a key condition for optimizing battery life. Combining the characteristics of photovoltaic power generation, a low-temperature energy storage management scheme is designed to effectively extend the life of lithium batteries. This scheme not only reduces the energy consumption of the energy storage system, but also significantly extends the life of the energy storage system, improving the overall economy and safety of the system. Through the scientific layout of the energy storage life extension system and the precise temperature monitoring strategy, this invention achieves battery life extension in low-temperature environments in the field of photovoltaic energy storage, providing a new technical path and economic model for large-scale, long-cycle distributed energy storage applications.

Specifically, the present invention discloses an energy storage life extension system for solar power generation, characterized in that:

Includes functional units: battery module, photovoltaic power generation unit, battery management system, and low-temperature life extension module;

The battery module is composed of multiple individual battery cells connected in series and/or in parallel, and multiple battery modules can also be connected in series and/or in parallel to form a battery cluster;

The photovoltaic power generation unit is electrically connected to the battery module, which can convert solar energy into electrical energy and charge the battery module.

The functions of the battery management system include: real-time monitoring and data acquisition of the operating parameters of the battery module;

The low-temperature life extension module is used to maintain the temperature of the battery module within the low-temperature operating range, so as to extend the battery life through active cooling, rather than just preventing the battery from overheating or thermal runaway.

The low-temperature operating range is a low-temperature range that is below room temperature but above the dew point;

While the battery module can have its lifespan extended when used in the low-temperature operating range, its capacity will be reduced due to the decrease in the electrochemical reaction rate.

Each functional unit, subsystem, subcomponent or device in the energy storage life extension system is optional. The electrical-related parts have a sealed structure to suppress low-temperature condensation and improve adaptability in low-temperature scenarios.

The operating parameters include, but are not limited to: voltage, current, power, temperature, and other parameters that can characterize the battery's operating performance, safety, and lifespan; and are applicable to both battery modules and individual cells or battery clusters.

The advantage of this solution is that it actively regulates the temperature of the battery module through the low temperature life extension module, so that it can maintain the best life at low temperature, thereby significantly extending the service life of the energy storage system and reducing the replacement cost; its significance is that it provides a solution for solar power generation and energy storage that takes into account both life and safety, while using low temperature to slow down battery aging.

Optionally, the low-temperature life extension module may adopt passive heat dissipation temperature control measures.

Optionally, the battery management system further includes: constraining and controlling the operating parameters of the battery module so that they do not exceed a preset threshold during charging and discharging, thereby preventing the battery module from aggravating side reactions under adverse operating conditions.

Optionally, the outer shell structure of the battery module can be designed as a multi-layer heat insulation and heat dissipation structure, which can enhance environmental adaptability and is suitable for high humidity, high salt spray and strong ultraviolet environment.

This design can improve the safety and reliability of the battery module, extend its service life, and maintain stable performance in a variety of complex environments, thereby reducing maintenance costs and improving the overall system efficiency.

Optionally, the low-temperature life extension module can adopt any active temperature control measure or passive temperature control measure as needed, or combine multiple methods, and/or combine structural optimization, cooling channel design and intelligent temperature control algorithm, so that the battery module can be maintained in the low-temperature working range under different working conditions.

Optionally, the active temperature control measures include air cooling, liquid cooling, spray cooling, immersion liquid cooling, thermoelectric refrigeration, refrigerant compression cycle, and heat pump system, and can dynamically and accurately adjust the heat dissipation efficiency or temperature control intensity according to real-time temperature changes to achieve rapid cooling and precise temperature control; the passive temperature control measures include natural convection heat dissipation, thermally conductive materials and heat sinks, phase change material heat absorption, evaporative cooling, heat pipes and loop heat pipes, heat spreaders, and heat insulation and heat preservation structures, which can effectively reduce heat dissipation energy consumption.

Optionally, the battery module is also configured with a capacity redundancy function; the capacity redundancy function compensates for the capacity loss caused by low temperature to the battery module by pre-configuring additional capacity for the battery module, ensuring that the battery module can meet the external power grid connection requirements at any time; wherein, the capacity redundancy function is an optional configuration.

Optionally, the operating parameters may also include current change rate, voltage change rate, temperature distribution, temperature rise rate, state of charge, health status, number of cycles, depth of discharge, internal resistance, impedance, polarization voltage, open circuit voltage and SOC relationship deviation, side reaction related indicators, insulation status, leakage current, short circuit characteristic parameters, pressure or gas concentration, and mechanical stress parameters.

Optionally, the specific implementation of the capacity redundancy function of the battery module includes hard redundancy and soft redundancy.

Optionally, the hard redundancy is achieved by configuring a certain proportion of redundant battery cells. The battery module can monitor the external power grid connection demand in real time. When the external power grid connection demand exceeds the capacity of the battery module, the battery module can control the activation of the redundant battery cells and use them in conjunction with the battery module itself, thereby ensuring that the total capacity of the battery module and the redundant battery cells can meet the external power grid connection demand.

The grid connection demand refers to the need for the battery energy storage system to dynamically exchange energy according to the grid's operating status and dispatch requirements when connected to the grid. It is bidirectional: when there is a power shortage in the grid, the battery module needs to release electrical energy according to grid instructions to support the stable operation of the grid; when there is a power surplus in the grid, the battery module needs to absorb electrical energy from the grid and store it to smooth peak flows or improve the utilization rate of renewable energy. Therefore, the grid connection demand includes not only the grid's discharge requirements for the battery module but also its charging requirements. The battery module monitors this bidirectional demand in real time and, combined with its own capacity and redundant cell configuration, ensures that it can flexibly respond to the grid's energy dispatch.

Optionally, in the initial design phase of the battery module, the soft redundancy presets the total capacity of the battery module to be higher than the required power grid connection demand by a certain proportion. The battery module is kept in a low load state during normal operation. When the external power grid connection demand increases significantly, the battery module can also be automatically switched to a high load state through intelligent control algorithm to ensure that the overall capacity of the battery module meets the external power grid connection demand.

This design can significantly improve the reliability and availability of the battery module under extreme temperatures, ensuring that it can stably meet load requirements even in low-temperature environments. At the same time, the combination of hard redundancy and soft redundancy can optimize capacity management, reduce performance degradation caused by cell loss or load fluctuations, thereby extending battery life and improving the overall stability and safety of the system.

Optionally, when the integrated control module detects that one or more operating parameters are close to or exceed the preset threshold, it will activate the corresponding protection strategy. The protection strategy may include, but is not limited to: reducing the charging current, reducing the discharging current, reducing the charging and discharging power or voltage, performing circuit disconnection operation, and/or outputting alarm prompts.

Optionally, the energy storage life extension system itself, or its various functional units, subsystems, sub-components or sub-devices, can be regarded as modularly installed external units, which can be quickly assembled, disassembled, maintained, expanded and upgraded through quick connectors, and can be configured according to actual temperature control requirements. It can also support the on-site modification and upgrading of existing energy storage battery containers without changing their inherent waterproof and dustproof structure.

Optionally, the functional units of the low-temperature life extension module may also include a heat exchanger and a fluid circulation pipeline.

Optionally, the heat exchanger is in direct contact with or indirectly connected to the battery module to absorb the heat generated by the battery module.

Optionally, the heat exchanger is in direct contact with or indirectly connected to the fluid circulation pipe, thereby transferring heat to the fluid circulation pipe. The fluid circulation pipe is also provided with a fluid medium circulating inside to improve heat exchange efficiency.

Optionally, the fluid circulation pipe can transfer the absorbed heat to the outside or to other heat dissipation components to achieve effective heat dissipation of the battery module.

Optionally, the fluid circulation pipeline can also recover and utilize some of the heat according to actual needs, thereby improving the overall energy utilization efficiency.

Optionally, the functional units of the low-temperature life extension module also include a buried pipeline system.

Optionally, the fluid circulation pipe is directly or indirectly connected to the underground pipeline system, thereby transferring heat to the underground pipeline system and releasing the heat underground or introducing it into other low-temperature cold sources through the underground pipeline system.

This design can effectively manage the temperature of the battery module, realize heat recovery and balanced distribution, thereby maintaining stable battery performance in low temperature environment and reducing the impact of low temperature on lifespan and capacity.

Optionally, the energy storage life extension system, or its functional units, subsystems, subcomponents or devices, may be equipped with a temperature equalization device to ensure uniform temperature distribution and avoid the generation of local hot spots.

This design ensures a uniform internal temperature of the battery module, preventing local overheating from affecting performance and lifespan. At the same time, the modular and quick-connect design facilitates rapid maintenance, expansion, and upgrades, improving operation and maintenance efficiency, and supports compatible retrofitting of existing energy storage systems, reducing overall retrofitting costs.

Optionally, the functional units of the energy storage life extension system also include safety protection devices, whose functions include, but are not limited to: multi-level over-temperature protection, overcharge and over-discharge protection, short circuit protection, insulation detection, thermal runaway suppression, fire alarm and automatic power off.

This design can comprehensively improve the safety and lifespan of the battery module and prevent risks such as overheating, overcharging, short circuit and thermal runaway through multiple protection mechanisms.

Optionally, the low-temperature life extension module is further equipped with a refrigeration device. The refrigeration device can be directly or indirectly connected to the energy storage life extension system itself or its various functional units, subsystems, sub-components or sub-devices through a pipeline system to achieve forced heat dissipation. When the passive heat dissipation capacity of the low-temperature life extension module is insufficient to keep the battery module in the low-temperature operating range, the refrigeration device can be activated to provide additional cooling capacity to ensure that the battery module is kept in the low-temperature operating range.

This design can precisely regulate the temperature of the battery module through various cooling methods in low-temperature environments, ensuring that it is stably maintained in the low-temperature operating range, thereby optimizing battery performance and extending service life.

Optionally, the photovoltaic power generation unit can also be replaced with a wind power generation unit, so that it can be flexibly applied to wind power generation scenarios and realize efficient conversion and storage of wind energy.

Optionally, the surface of the photovoltaic power generation unit is provided with a nanostructure anti-reflective coating, a self-cleaning coating and a photocatalytic anti-pollution layer.

Optionally, the photovoltaic power generation unit may also be equipped with an inverter module with a maximum power point tracking algorithm (including but not limited to perturbation observation method, hill climbing method, and AI optimization algorithm), and may also support centralized, string and micro inverter architectures, support multiple inputs and intelligent power distribution, and ensure the highest photoelectric conversion efficiency under varying lighting conditions.

Optionally, the low-temperature life extension module can also predict underground temperature, weather changes, and power generation of the power generation unit, and automatically adjust heat dissipation or cooling strategies to ensure that the battery module is maintained in the low-temperature operating range.

This design enables flexible integration of photovoltaic and wind power generation, making the energy storage life extension system applicable to various renewable energy scenarios. At the same time, through intelligent power management, maximum power point tracking and automatic temperature control strategies, energy conversion and storage can be efficiently adjusted when sunlight or wind conditions change.

Optionally, the specific range of the low-temperature operating range may vary depending on various factors, including the battery chemistry system, capacity, rated operating voltage and specific application environment conditions.

Optionally, the determination of the low-temperature operating range can be diversified. It can be determined through laboratory tests, bench tests, or comprehensive analysis, including but not limited to using multi-temperature, multi-cell cycle life tests, accelerated decay tests, and thermal characteristic studies to evaluate the capacity decay, life change, and safety performance of the battery under low-temperature conditions, thereby determining its applicable low-temperature operating range; it can also be selected based on actual experience and the parameter range provided by the manufacturer, or predicted by combining battery thermal management models, life decay models, and kinetic simulation methods; in addition, it can also be determined by using historical operating data for statistical modeling, or by using multi-parameter coupling optimization methods.

This design can flexibly determine the low-temperature operating range according to the battery type, capacity and usage environment, thereby achieving targeted temperature control and lifespan optimization. The low-temperature range can be determined by various methods such as experiments, simulations and historical data analysis, which can accurately match the battery performance requirements.

Optionally, the flow of the fluid medium is driven by an electric pump, a magnetic pump, a compressor or gravity, and the low temperature life extension module can be equipped with a multi-way switching valve, a flow regulating valve, a temperature sensor and a control device as needed, so as to automatically adjust the fluid flow rate, temperature and flow path according to the battery temperature, so as to achieve dynamic control of the required temperature.

Optionally, the fluid medium may be switched or mixed as needed during operation to adapt to different environmental conditions and optimize heat exchange efficiency and energy consumption.

Optionally, the battery module can be divided into several thermal management zones, each zone is equipped with an independent fluid circulation pipeline and flow regulator, so as to realize independent and precise control of the temperature of each zone and to stably maintain the temperature of each zone in the low temperature working range.

Optionally, all the pipes in the low-temperature life extension module are switchable. A heat transfer medium with a high thermal conductivity can be injected when needed, or an insulation layer can be formed by evacuation, so as to realize the rapid switching of the system between the “strong cooling” and “heat preservation” modes.

This design enables intelligent switching between battery system life extension and high power output, dynamically optimizes performance and lifespan consumption, and provides data support for operation and maintenance decisions. Through refined zoned thermal management and intelligent fluid control, the temperature of each zone can be independently adjusted, ensuring that the system can operate efficiently and reliably under different environmental and load conditions.

Optionally, each functional unit, subsystem, subcomponent or device in the energy storage life extension system itself can be equipped with a multi-point temperature sensor and the collected temperature information can be fed back to the intelligent control algorithm in real time to ensure that the battery module is maintained in the low temperature operating range.

Optionally, the energy storage life extension system can dynamically adjust the execution order, operation mode, operation parameters and operation intensity of each functional unit or component according to the environmental state and load requirements of the battery module to achieve adaptive frequency conversion control, or reconstruct or switch the topological connection structure of each functional unit or component as needed to ensure that the battery module is maintained in the low temperature operating range.

This design achieves rapid response between “strong cooling” and “heat preservation” modes by using switchable heat conduction channels and high-precision multi-point temperature control, ensuring stable temperature of the battery module under different environments. Combined with various intelligent control algorithms and dynamic operation strategies, the system operation mode, parameters and topology can be flexibly adjusted according to real-time load and environmental changes.

Optionally, the temperature equalization device includes one or a combination of the following: coated phase change material, microcapsule phase change material or composite phase change material layer, liquid cooling temperature equalization plate, microchannel cooling plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange or aerogel insulation-thermal conductive composite structure.

Optionally, the melting point of the phase change material can be precisely set by alloy formulation optimization or microcapsule encapsulation technology. It can also be arranged in a hierarchical array in spatial distribution, or a variety of phase change materials with different melting points can be deployed and combined with underground seasonal thermal energy storage (summer cold storage and winter cold release) to achieve efficient temperature control optimization across application scenarios, seasons and days and nights, thereby reducing the energy consumption of active cooling/heating.

Optionally, the melting point of the phase change material can be precisely set to any of the following values (not an exhaustive list), or precisely set to any value within the range of ±2.5 °C: 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, −22.5 °C, −25 °C.

This design achieves efficient temperature control of the battery module across seasons, day and night, and various application scenarios through diverse temperature equalization devices and precisely controllable phase change materials. By utilizing graded arrays or multi-melting-point phase change materials, the energy consumption of active heating or cooling can be significantly reduced, and thermal management efficiency can be improved.

Optionally, the functional unit of the energy storage life extension system also includes a data acquisition module, which includes wired and wireless communication devices, supports multiple communication protocols including LTE, 5G, WiFi or LoRa, and uploads system operation status data and environmental data to the cloud platform in real time to realize remote monitoring, data analysis and fault diagnosis, and supports big data and AI-driven operation and maintenance management.

Optionally, the energy storage life extension system also supports the installation of solar shading facilities, including adjustable shading panels, shading curtains or shading canopies, to effectively reduce the heat load of the battery container; the solar shading facilities can also dynamically adjust the incident heat according to the ambient temperature, solar irradiance and battery temperature.

Optionally, the functional units of the energy storage life extension system may further include a heat preservation system, a small reversible heat pump or an electric heating unit.

Optionally, when the ambient temperature is too low, the heat preservation system can quickly reduce the heat exchange efficiency of any functional unit or its components, thereby avoiding the battery module temperature from being too low.

Optionally, the small reversible heat pump can be started for a short time under extreme low temperature conditions to return some heat energy to the battery module to prevent the battery module temperature from getting too low.

Optionally, the electric heating unit can be activated for a short time under extreme low temperature conditions to provide compensatory heating, so that the battery module temperature is stably maintained in the life-extending temperature range rather than in an overcooled state.

This design achieves real-time remote monitoring and intelligent operation and maintenance through data acquisition and multiple communication protocols, providing data support for the reliable operation of the system. At the same time, combined with adjustable solar shading facilities, insulation system, small reversible heat pump and electric heating unit, it achieves precise management of battery module temperature and maintains the extended life temperature range in low temperature or strong light environment.

Optionally, the functional unit of the low-temperature life extension module further includes a dehumidification device; the dehumidification device can be automatically activated when the battery module temperature is close to the dew point to reduce the air humidity around the battery module, thereby reducing the dew point temperature, preventing condensation on the battery surface, and ensuring the safe operation of the battery.

Optionally, when the ambient humidity is high and the battery module temperature is close to the dew point, the energy storage life extension system can adjust the heat exchange efficiency of each functional unit or component, or activate the insulation system, small reversible heat pump or electric heating unit to maintain the battery module temperature at a level higher than the dew point, thereby preventing condensation and avoiding moisture or electrical short circuit inside the battery module.

This design effectively prevents condensation on the surface and inside of the battery module through a dehumidification device and temperature control strategy, reducing the safety risks caused by moisture. Combined with heat exchange regulation, insulation system, small reversible heat pump and electric heating unit, the battery temperature can be kept above the dew point in high humidity environments.

Optionally, the battery management system further includes the following functions: dynamically adjusting the charging and discharging rate of the battery module based on battery state estimation (SoC), state of health estimation (SoH), temperature data and life prediction model through intelligent control algorithm.

Optionally, the battery management system not only controls charging and discharging, but also dynamically allocates the load according to the temperature, capacity and life status of each module to achieve low-temperature life extension and capacity balance; the dynamic allocation is achieved through intelligent scheduling between battery modules to avoid excessive damage to some battery modules.

Optionally, the battery module can automatically put some of its battery cells into a sleep or wake-up mode based on the battery health status and load prediction; the battery management system can combine multi-point sensors and intelligent control algorithms to determine which modules should be put into sleep or activated in advance.

Optionally, the battery management system also includes: fault detection, alarm and self-protection functions, thereby preventing overcharging, over-discharging, overheating, short circuit and imbalance.

This design achieves real-time monitoring and intelligent control of battery module voltage, current, temperature, and health status through an advanced battery management system. It combines dynamic charge and discharge regulation, inter-module load distribution, and sleep/wake-up strategies. At the same time, fault detection and self-protection functions can prevent overcharging, over-discharging, over-temperature, and short circuits, comprehensively improving the safety and reliability of the battery system.

Optionally, the battery management system also includes the following functions: enabling data interaction with the photovoltaic inverter and the upper-level monitoring system through communication interfaces (such as CAN, Modbus, and wireless communication) to support remote maintenance and upgrades.

Optionally, the battery management system further includes an optimized charge and discharge protocol for the low-temperature operating range, the protocol including staged current limiting, pulse charging and depolarization pulse, to alleviate or repair charge and discharge damage under low-temperature conditions.

Optionally, the battery management system can combine electrochemical materials or added repair agents and current pulse strategies to locally inhibit SEI film growth or implement “dormant repair” and isolate the aging module for repair during off-peak periods.

This design enables remote data interaction with the photovoltaic inverter and the upper-level monitoring system through the battery management system, supporting system maintenance and upgrades. Combined with the low-temperature optimized charge and discharge protocol, it can effectively alleviate or repair charge and discharge damage under low-temperature conditions. At the same time, through local SEI film suppression and “dormant repair” strategies, it helps to delay battery aging and repair performance degradation modules.

Optionally, the upper limit of the low-temperature working range can be selected from the following preset temperature values (the following values are only examples and not limitations), and can be adjusted within ±2.5°C of the listed values. The selectable temperature points for the upper limit include: 35 °C, 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, and −22.5 °C.

Optionally, the lower limit of the low-temperature working range can also be selected from the following preset temperature values (the following values are examples), and can be adjusted within ±2.5 °C of the listed temperature points. The candidate values include: 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, −22.5 °C, and −25 °C.

This design achieves precise control of the battery module temperature by adjusting the upper and lower limits of the low-temperature working range. It can flexibly set the optimal temperature control range for different battery types, capacities and application environments, and improve the system's adaptability and reliability under various environmental conditions.

Optionally, the type of the multi-point temperature sensor includes thermocouples, thermistors (RTDs), semiconductor temperature sensors or infrared temperature sensors.

Optionally, multiple temperature sensors can also be arranged at different locations of the battery module to monitor the temperature distribution of each area in real time, so that the battery management system can dynamically adjust the flow rate or temperature of the fluid medium according to the temperature difference at different locations, thereby achieving targeted cooling or heat preservation and extending battery life.

Optionally, the functional units of the energy storage life extension system further include an environmental monitoring unit, which is equipped with a soil temperature sensor, a soil moisture sensor, an ambient temperature sensor, a relative humidity sensor, an air pressure sensor, a wind speed sensor, and a light intensity sensor.

Optionally, the energy storage life extension system can combine edge computing devices to analyze the data obtained by the environmental monitoring unit, calculate and adjust the temperature and flow rate of the fluid inside each pipe, ensure the efficient operation of each functional unit, and prevent excessive cooling from causing ice or condensation on the surface of the battery module.

Optionally, the sensors equipped in the energy storage life extension system can be connected through a wireless self-powered network. Each sensor node is powered by ambient energy (including thermoelectric power generation, wind or solar energy), eliminating the need for wiring, thereby avoiding wiring failures and improving measurement reliability and system maintainability.

This design achieves real-time and precise monitoring of the battery module and its surrounding environment through multi-point temperature sensors and an environmental monitoring unit. Combining edge computing and dynamic fluid medium regulation, it can achieve precise cooling or insulation for different locations and environmental conditions, preventing icing or condensation and extending battery life. At the same time, the wireless self-powered sensor network reduces wiring requirements.

Optionally, the battery module is configured with a controllable power switch array, a solid-state switch, a smart contactor array, a mechanical latch, or an electrical quick connector, so that the system can dynamically adjust the series/parallel connection mode of the individual cells or the battery module; wherein, at the individual cell level, the series/parallel connection relationship of the individual cells can be dynamically switched according to the temperature, internal resistance, and remaining capacity of each individual cell; the series/parallel connection relationship of the battery module can also be dynamically switched at the battery module level according to the temperature, internal resistance, and remaining capacity of each battery module.

Optionally, the functional unit of the energy storage life extension system further includes a power generation prediction module; the power generation prediction module can predict the power generation for a preset period of time based on meteorological forecast data, real-time irradiance sensor data and photovoltaic array working status, and communicate with the battery management system to input the prediction results and battery temperature distribution and remaining capacity information into the intelligent control algorithm, so as to increase the heat preservation or heat storage intensity in advance during periods of expected low power generation or low temperature environment; and prioritize the allocation of cooling and charging/discharging capacity during periods of expected high power generation or high load demand, so as to take into account both energy utilization efficiency and battery life.

This design achieves flexible energy management of individual cells and modules through a controllable power switch array and dynamic series/parallel adjustment, which can alleviate local capacity decay at low temperatures and improve the overall available energy and output power of the system. At the same time, combined with the power generation prediction module and intelligent control algorithm, the insulation, heat storage and cooling strategies can be adjusted in advance according to future power generation and load conditions.

Optionally, the battery management system establishes a digital twin model of the battery pack and connects to weather forecast data and power generation forecast data. It adopts model predictive control, reinforcement learning algorithm or other intelligent control algorithm to optimize fluid flow regulation, redundant module start-up and shutdown and charging and discharging plan in advance, so as to realize active prediction and adaptive operation strategy, so as to balance energy efficiency and battery life extension.

Optionally, the battery management system can also simulate and predict the impact of different temperature control strategies on the entire battery life cycle based on the digital twin model, and dynamically optimize the field control parameters accordingly to achieve a balance between long life and operating efficiency; the battery management system also includes cloud-based deployment.

Optionally, the functional units of the energy storage life extension system also include a system controller, which can intelligently adjust the operating status of each functional unit based on weather forecast data, load prediction, battery life optimization algorithm or other intelligent control algorithm, adjust the flow rate and temperature of the fluid medium, realize the switching between energy-saving mode and high-performance mode, and optimize the overall energy efficiency ratio of the system.

This design establishes a digital twin model of the battery pack and combines it with weather and power generation forecast data to achieve proactive optimization based on model predictive control, reinforcement learning, and other intelligent algorithms. The system can adjust fluid flow rate, redundant module start/stop, and charging/discharging strategies in advance to achieve adaptive operation. By simulating and predicting the full life cycle impact of different temperature control strategies, and combining the intelligent controller to dynamically adjust the flow rate of the fluid medium or the operating status of each functional unit, it can flexibly switch between energy-saving mode and high-performance mode.

The energy storage life extension system design proposed in this case has significant advantages in terms of ease of modification. Specifically, the battery container in the existing photovoltaic energy storage equipment does not need to be dismantled or modified on a large scale and can still be placed on the ground, maintaining the integrity of the original waterproof and dustproof structure. This not only saves modification costs but also greatly simplifies the on-site construction difficulty. By introducing a closed-loop underground pipeline system, this case achieves efficient transfer of the heat generated by the battery to the underground natural low-temperature environment, thereby achieving a stable and continuous cooling effect. The stable underground temperature environment can maintain an ideal working range of 0 °C to 15 °C for the battery, making full use of the life extension advantage of the low-temperature environment, while avoiding the high energy consumption problem of traditional refrigeration systems. It is worth mentioning that while keeping the battery box unchanged, this solution can flexibly configure auxiliary facilities according to actual needs. For example, solar shading equipment can be installed above the photovoltaic array to reduce the heat input of direct sunlight to the battery box and further optimize the system temperature management. In addition, in order to improve the heat exchange efficiency in the pipeline, the system supports integrated refrigeration equipment to cope with the temporary adjustment needs of extreme high-temperature environments and enhance the system's adaptability and stability. To enhance heat exchange efficiency within the pipeline, the design allows for the configuration of a circulating pump system, enabling continuous flow of fluid or air within the pipeline to accelerate heat transfer and dissipation. This circulation system can dynamically adjust the flow rate based on environmental conditions and load, achieving intelligent temperature control management and ensuring the battery temperature remains within its optimal range. The diversification of pipeline materials and heat dissipation media is also a key innovation of this project. The pipeline can utilize internal ventilation for air cooling, resulting in a simple and cost-effective structure; alternatively, liquid fluid media, such as water or coolant, can be used to improve heat exchange efficiency. The design incorporates solid metal components for pipelines, utilizing their high thermal conductivity for heat dissipation, making it suitable for scenarios with extremely high heat exchange requirements. To reduce overall system cost and maintenance complexity, this project also supports the use of non-metallic pipeline materials, such as high-performance plastics or composite materials, balancing cost-effectiveness and durability, and flexibly adapting to different soil and environmental conditions. Compared to the high-energy-consuming heat dissipation solutions built into traditional energy storage systems, this project achieves low-energy, long-term temperature management through buried pipelines combined with passive heat dissipation from the natural low-temperature environment, significantly reducing operating energy consumption and maintenance costs. Traditional cooling systems typically require continuous operation of fans, pumps, or chillers, which not only increases energy consumption but also accelerates the aging of batteries and cooling equipment, affecting system reliability and lifespan. Furthermore, some existing energy storage solutions attempt to utilize natural cold sources, such as seawater and river water, but are often limited by complex system layouts, including the manufacturing requirements of special pressure-resistant casings, complex water circuit designs, and distance constraints between the cold source and the energy storage equipment. These limitations result in high equipment costs, difficult installation and maintenance, and poor environmental adaptability, restricting their widespread adoption. This project innovatively employs a closed-loop buried pipeline system, eliminating the need for special pressure-resistant casings or long-distance cold source transportation, while maintaining flexibility in equipment layout and environmental adaptability, achieving a cost-effective photovoltaic energy storage temperature control solution. By seamlessly integrating with the natural low-temperature environment of the photovoltaic power generation site, it ensures the optimal operating temperature of the batteries and improves the system's economic efficiency and sustainable operation capabilities.

### BRIEF DESCRIPTION OF DRAWINGS

In order to more clearly illustrate the technical solutions in the embodiments of the present invention, the drawings used in the embodiments will be briefly introduced below. Obviously, the drawings described below are only one embodiment of the present invention. For those skilled in the art, other drawings can be obtained based on these drawings without creative effort.

FIG. 1 is a schematic diagram of an energy storage life extension system for solar power generation according to an embodiment of the present invention. FIG. 2 shows the original experimental data to demonstrate the low-temperature life extension effect of this invention.

Battery module 101, photovoltaic power generation unit 201, battery management system 301, low temperature life extension module 401.

### DETAILED DESCRIPTION OF THE INVENTION

Several exemplary embodiments of the present disclosure will be described in detail below with reference to the accompanying drawings. The following description applies to various embodiments of the present invention, and the preferred embodiment is only one of them. It should be understood that the embodiments and drawings of the present disclosure are merely illustrative examples used to help understand the technical solutions and effects of the present disclosure, and should not be regarded as a limitation on the scope of protection of the present disclosure. The drawings are merely schematic, and the number, shape, size and layout of the components shown can be flexibly adjusted or modified according to actual needs. In practical applications, the present disclosure can be implemented in various forms, and the details in the embodiments can be modified according to different needs or application scenarios without departing from the core technical ideas of the present disclosure.

After understanding the principles and technical ideas of this disclosure, those skilled in the art can adjust, optimize, improve, replace, or combine the embodiments, including functional module reorganization, sequence adjustment, system expansion, parameter optimization, and implementation method change, without deviating from the core technical ideas of this disclosure. These modifications, combinations, or optimizations should all be considered part of the scope of protection of this disclosure. The terms used in this specification, including technical and scientific terms, should have the same meaning as understood by those skilled in the art, unless explicitly stated otherwise. Where necessary, known technologies, methods, or devices involved in this disclosure should be considered part of the specification to better understand the content of this disclosure, but do not constitute a limitation on the scope of protection of this disclosure. For simplified description, some structures or devices may be represented by block diagrams or simplified representations, which do not affect the understanding of the embodiments.

This invention discloses an energy storage life extension system for solar power generation, which is particularly suitable for use with solar power generation. It can significantly extend the life of the energy storage system, effectively control system energy consumption, and achieve a balance between economy and safety throughout the entire life cycle, and has extremely high application prospects.

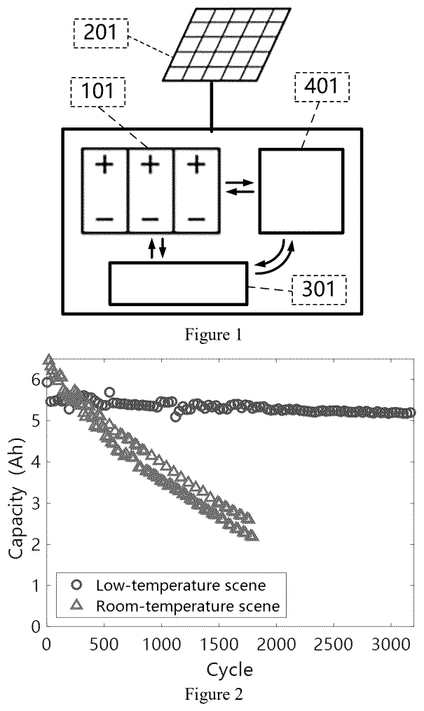

FIG. 1 is a schematic diagram of an energy storage life extension system for solar power generation according to some embodiments of the present disclosure. In some embodiments, the energy storage life extension system is characterized by including functional units: battery module 101, photovoltaic power generation unit 201, battery management system 301, and low temperature life extension module 401;

The battery module 101 is composed of multiple individual battery cells connected in series and/or in parallel, and multiple battery modules 101 can also be connected in series and/or in parallel to form a battery cluster.

The photovoltaic power generation unit 201 is electrically connected to the battery module 101, and can convert solar energy into electrical energy and charge the battery module 101;

The functions of the battery management system 301 include: real-time monitoring and data acquisition of the operating parameters of the battery module 101;

The low-temperature life extension module 401 is used to maintain the temperature of the battery module 101 in the low-temperature operating range so as to extend the battery life through active cooling, rather than just preventing the battery from overheating or thermal runaway.

The low-temperature operating range is a low-temperature range that is below room temperature but above the dew point; the battery module 101 is used in the low-temperature operating range, although its lifespan can be extended, its capacity will be reduced due to the decrease in the electrochemical reaction rate.

Each functional unit, subsystem, subcomponent or device in the energy storage life extension system is optional. The electrical-related parts have a sealed structure to suppress low-temperature condensation and improve adaptability in low-temperature scenarios.

The operating parameters include, but are not limited to: voltage, current, power, temperature, and other parameters that can characterize the battery's operating performance, safety, and lifespan; and are applicable to both battery modules and individual cells or battery clusters.

The definition of the low-temperature working range is illustrated by the following example: The ambient temperature value is determined according to specific application requirements and can be 20 °C, 25 °C, 30 °C, or other suitable temperatures. The dew point temperature is calculated based on the ambient temperature and relative humidity; for example, under the conditions of an ambient temperature of 25 °C and a relative humidity of 60%, the dew point temperature is approximately 16 °C. Those skilled in the art can flexibly set the low-temperature working range according to different environmental conditions and experimental conclusions to ensure the operability and universality of the present invention. For example, the low-temperature working range can be set to 16 °C to 20 °C (the ambient temperature value and the ambient temperature may be inconsistent).

In some embodiments, the low-temperature life extension module may employ passive heat dissipation temperature control measures.

In some embodiments, the battery management system further includes: constraining and controlling the operating parameters of the battery module so that they do not exceed a preset threshold during charging and discharging, thereby preventing the battery module from aggravating side reactions under adverse operating conditions.

In a battery management system, preset thresholds are an important means of constraining battery operating parameters, and may include upper limit protection or lower limit protection. Upper limit protection is used to prevent battery parameters from being too high, such as excessive charging current, in order to reduce side reaction rates and structural damage; lower limit protection is used to prevent parameters from being too low, such as excessively low discharge voltage, which can cause irreversible capacity loss. The preset threshold can be a unilateral constraint, limiting only the upper or lower limit, or a bilateral constraint, limiting both the upper and lower limits simultaneously, to ensure that the battery remains safe and its lifespan is extended during operation.

Taking ternary lithium batteries as an example, according to the terminology of this case, the life extension scheme can be described as follows: the low temperature operating range is selected as 5 °C~15 °C, the operating parameter is selected as instantaneous charging current, and the preset threshold is selected as 1 C charging rate (upper limit control), corresponding to a life extension effect of 2 times the cycle life. In layman's terms, if the charging current does not exceed 1 C when the ternary lithium battery is running in the temperature range of 5 °C~15 °C, its cycle life can be extended by about 2 times. For lithium iron phosphate batteries, according to the terminology of this case, the life extension scheme can be described as follows: the low temperature operating range is selected as 0 °C~10 °C, the operating parameters are selected as instantaneous charging current and instantaneous discharging current, and the preset thresholds are selected as 3 C charging rate (upper limit control) and 6 C discharging rate (upper limit control) respectively, corresponding to a life extension effect of 3 times the charge and discharge throughput life. In layman's terms, if the charge and discharge current does not exceed 3 C and 6 C respectively when the lithium iron phosphate battery is running in the temperature range of 0 °C~10 °C, its charge and discharge throughput life can be extended by about 3 times.

In general, the control strategy under low-temperature operation mainly includes ensuring that the battery operates in the low-temperature range, while reducing the charging and discharging current to slow down the side reaction rate, thereby extending the battery life. Usually, the limitation on the charging current is more stringent than that on the discharging current, because the charging process has a greater impact on the battery side reactions. This strategy can be adjusted according to the characteristics of different battery chemical systems. By combining low-temperature life extension and operating condition parameter threshold control, the battery life can be effectively extended.

In some embodiments, the housing structure of the battery module can be designed as a multi-layer heat insulation and heat dissipation structure, which can enhance environmental adaptability and is suitable for high humidity, high salt spray and strong ultraviolet environment.

In some embodiments, the low-temperature life extension module can adopt any active or passive temperature control measures as needed, or combine multiple methods, and/or combine structural optimization, cooling channel design and intelligent temperature control algorithm, so that the battery module can be maintained in the low-temperature operating range under different working conditions.

In some embodiments, the active temperature control measures include air cooling, liquid cooling, spray cooling, immersion liquid cooling, thermoelectric cooling, refrigerant compression cycle, and heat pump system, and can dynamically and accurately adjust the heat dissipation efficiency or temperature control intensity according to real-time temperature changes to achieve rapid cooling and precise temperature control; the passive temperature control measures include natural convection heat dissipation, thermally conductive materials and heat sinks, phase change material heat absorption, evaporative cooling, heat pipes and loop heat pipes, heat spreaders, and heat insulation and heat preservation structures, which can effectively reduce heat dissipation energy consumption.

In some embodiments, the battery module is also configured with a capacity redundancy function; the capacity redundancy function compensates for the capacity loss caused by low temperature to the battery module by pre-configuring additional capacity for the battery module, ensuring that the battery module can meet the external power grid connection requirements at any time; wherein, the capacity redundancy function is an optional configuration.

In some embodiments, the operating condition parameters further include current change rate, voltage change rate, temperature distribution, temperature rise rate, state of charge, health status, number of cycles, depth of discharge, internal resistance, impedance, polarization voltage, open circuit voltage vs. SOC relationship offset, side reaction related indicators, insulation status, leakage current, short circuit characteristic parameters, pressure or gas concentration, and mechanical stress parameters.

In some embodiments, the specific implementation of the capacity redundancy function of the battery module includes hard redundancy and soft redundancy.

In some embodiments, the hard redundancy is achieved by configuring a certain proportion of redundant battery cells. The battery module can monitor the external power grid connection demand in real time. When the external power grid connection demand exceeds the capacity of the battery module, the battery module can control the activation of the redundant battery cells and use them in conjunction with the battery module itself, thereby ensuring that the total capacity of the battery module and the redundant battery cells can meet the external power grid connection demand.

In some embodiments, when the integrated control module detects that one or more operating parameters are close to or exceed the preset threshold, it will activate the corresponding protection strategy. The protection strategy may include, but is not limited to: reducing the charging current, reducing the discharging current, reducing the charging and discharging power or voltage, performing circuit disconnection operation, and/or outputting alarm prompts.

In some embodiments, the soft redundancy is implemented in the initial design phase of the battery module, where the total capacity of the battery module is preset to be higher than the required power grid connection demand by a certain percentage. The battery module is kept in a low load state during normal operation. When the external power grid connection demand increases significantly, the battery module can also be automatically switched to a high load state through intelligent control algorithms to ensure that the overall capacity of the battery module meets the external power grid connection demand.

In some embodiments, the functional units of the low-temperature life extension module further include a heat exchanger and a fluid circulation pipeline.

In some embodiments, the heat exchanger is in direct contact or indirect communication with the battery module to absorb the heat generated by the battery module.

The direct contact or indirect connection includes a variety of methods. The direct contact method can be that the heat exchanger and the battery module are in close contact, and efficient heat conduction is achieved through thermally conductive materials. The indirect connection method can achieve heat transfer through thermally conductive plates, heat pipes or other thermal coupling structures, while avoiding structural interference or space limitations. Alternatively, an integrated design can be adopted to combine the heat exchanger and the battery module structure, thereby reducing thermal resistance and energy loss.

In some embodiments, the heat exchanger is in direct contact with or indirectly connected to the fluid circulation pipe, thereby transferring heat to the fluid circulation pipe. The fluid circulation pipe is also provided with a fluid medium circulating inside to improve heat exchange efficiency.

In addition, the heat exchanger can be built into the fluid channel so that the fluid can directly absorb heat; or the heat exchanger can be connected to the fluid circulation system through a connecting pipe or flow channel so that the circulating fluid can carry away the heat.

In some embodiments, the fluid circulation pipe can transfer the absorbed heat to the outside or to other heat dissipation components to achieve effective heat dissipation of the battery module.

In some embodiments, the fluid circulation pipeline can also recover and utilize some of the heat according to actual needs, thereby improving the overall energy utilization efficiency.

In some embodiments, the functional units of the low-temperature life extension module also include a buried pipeline system.

In some embodiments, the fluid circulation pipe is directly or indirectly connected to the underground pipeline system, thereby transferring heat to the underground pipeline system and releasing the heat underground or introducing it into other low-temperature cold sources through the underground pipeline system.

In some embodiments, the photovoltaic power generation unit can also be replaced by a wind power generation unit, so that it can be flexibly applied to wind power generation scenarios and realize efficient conversion and storage of wind energy.

In some embodiments, the energy storage life extension system, or its functional units, subsystems, subcomponents or devices, may be equipped with a temperature equalization device to ensure uniform temperature distribution and avoid the generation of local hot spots.

In some embodiments, the energy storage life extension system itself, or its various functional units, subsystems, sub-components or sub-devices, can be regarded as modularly installed external units that can be quickly assembled, disassembled, maintained, expanded and upgraded through quick connectors, and can be configured according to actual temperature control requirements. It can also support the on-site modification and upgrading of existing energy storage battery containers without changing their inherent waterproof and dustproof structure.

In some embodiments, the functional units of the energy storage life extension system further include safety protection devices, the functions of which include, but are not limited to: multi-level over-temperature protection, overcharge and over-discharge protection, short circuit protection, insulation detection, thermal runaway suppression, fire alarm and automatic power off.

In some embodiments, the low-temperature life extension module is further configured with a refrigeration device. The refrigeration device can be directly or indirectly connected to the energy storage life extension system itself or its various functional units, subsystems, sub-components or sub-devices through a pipeline system to achieve forced heat dissipation. When the passive heat dissipation capacity of the low-temperature life extension module is insufficient to keep the battery module in the low-temperature operating range, the refrigeration device can be activated to provide additional cooling capacity to ensure that the battery module is kept in the low-temperature operating range.

In some embodiments, the low-temperature life extension module can also predict underground temperature, weather changes, and power generation of the power generation unit, and automatically adjust heat dissipation or cooling strategies to ensure that the battery module is maintained in the low-temperature operating range.

In some embodiments, the photovoltaic power generation unit includes monocrystalline silicon, polycrystalline silicon, thin-film solar cells, perovskite and multi-junction solar cell modules.

In some embodiments, the low-temperature life extension module can also automatically adjust the heat dissipation or cooling strategy according to the underground temperature, the power generation of the photovoltaic power generation unit and the weather forecast to ensure that the battery module is maintained in the low-temperature operating range.

In some embodiments, the refrigeration equipment includes, but is not limited to, compression refrigeration equipment, thermoelectric refrigeration modules, absorption cooling equipment, air source refrigeration equipment, ground source heat pumps, water source heat pumps, evaporative cooling devices, mechanical compression refrigeration equipment or other devices capable of providing cooling capacity.

In some embodiments, the specific range of the low-temperature operating range may vary depending on various factors, including the battery chemistry system, capacity, rated operating voltage and specific application environment conditions.

In some embodiments, the determination of the low-temperature operating range can be diversified. It can be determined by laboratory tests, bench tests or comprehensive analysis, including but not limited to using multi-temperature, multi-cell cycle life tests, accelerated decay tests and thermal characteristic studies to evaluate the capacity decay, life change and safety performance of the battery under low-temperature conditions, thereby determining its applicable low-temperature operating range; it can also be selected based on actual experience and the parameter range provided by the manufacturer, or predicted by combining battery thermal management models, life decay models and dynamic simulation methods; in addition, it can also be determined by using historical operating data for statistical modeling, or by multi-parameter coupling optimization.

Specific methods for determining the low-temperature operating range include: multi-temperature, multi-cell cycle life testing, i.e., repeatedly charging and discharging under different temperature conditions to obtain information such as battery capacity decay curves, internal resistance change trends, and charge/discharge efficiency; accelerated decay testing, i.e., rapidly simulating long-term use conditions through high-rate or deep cycling to observe the performance degradation law at different temperatures; thermal characteristic research, i.e., analyzing the thermal balance behavior and safety performance of the battery by measuring its thermal resistance, thermal capacity, and heat generation capacity at different temperatures, providing a reference for setting the low-temperature operating range. A battery thermal management model can also be established to simulate the internal temperature distribution at different temperatures and the influence of temperature on electrochemical performance; or a lifespan decay model can be used to predict the impact of long-term low-temperature cycling or storage on capacity and internal resistance; or a kinetic simulation method can be used to analyze electrode reaction rate, ion diffusion, and interfacial impedance changes at low temperatures, providing a quantitative basis for the low-temperature operating range. Statistical modeling and analysis can also be performed using historical operating data, and regression analysis or machine learning methods can be used to obtain the battery's capacity decay trend, efficiency change, and abnormal behavior patterns under low-temperature conditions, thereby guiding the setting of the low-temperature operating range. Alternatively, through multi-parameter coupling optimization, experimental data, model prediction results, and operational experience can be comprehensively considered to achieve the optimal determination of the low-temperature operating range, taking into account battery life, performance, and safety.

In some embodiments, the flow of the fluid medium is driven by an electric pump, a magnetic pump, a compressor or gravity, and the low temperature life extension module can be equipped with a multi-way switching valve, a flow regulating valve, a temperature sensor and a control device as needed, so as to automatically adjust the fluid flow rate, temperature and flow path according to the battery temperature, so as to achieve dynamic control of the required temperature.

In some embodiments, the battery module can be divided into several thermal management zones, each zone is equipped with an independent fluid circulation pipe and flow regulator, so as to realize independent and precise control of the temperature of each zone and to stably maintain the temperature of each zone in the low temperature operating range.

In some embodiments, the various pipes in the low-temperature life extension module are switchable, and a heat transfer medium with high thermal conductivity can be injected when needed, or an insulation layer can be formed by evacuation, so as to realize the rapid switching of the system between “strong cooling” and “heat preservation” modes.

In some embodiments, the fluid medium is switched or mixed as needed during operation to adapt to different environmental conditions and optimize heat exchange efficiency and energy consumption.

In some embodiments, each functional unit, subsystem, subcomponent or device in the energy storage life extension system itself can be equipped with a multi-point temperature sensor and the collected temperature information is fed back to the intelligent control algorithm in real time to ensure that the battery module is maintained in the low temperature operating range.

In some embodiments, the types of intelligent control algorithms include, but are not limited to, predetermined strategies, adaptive methods, predictive methods, fuzzy control, PID control, machine learning, expert systems, large model algorithms, model predictive control, reinforcement learning, neural networks, generative large models and other data-driven or physical model-based optimization control methods, or organic integration of these algorithms.

In some embodiments, the energy storage life extension system can dynamically adjust the execution order, operation mode, operation parameters and operation intensity of each functional unit or component according to the environmental state and load requirements of the battery module, so as to achieve adaptive frequency conversion control, or reconstruct or switch the topology connection structure of each functional unit or component as needed, so as to ensure that the battery module is maintained in the low temperature operating range.

In actual operation, the optimal operating frequency can be intelligently calculated by monitoring parameters such as battery temperature, current, voltage, and ambient temperature, so that the heat dissipation unit or power regulation unit can operate with the lowest energy consumption while ensuring temperature stability. Alternatively, the system can switch between high-performance mode, energy-saving mode, and standby mode according to load fluctuations and battery status. For example, when the battery temperature rises, the frequency and airflow of the heat dissipation unit are increased; when the temperature drops to a safe range, the frequency is reduced to achieve energy saving. Alternatively, parameters such as fan speed, coolant pump speed, and current output can be adjusted to match the operating intensity of each functional unit with the battery thermal load, thereby preventing overcooling or overheating and extending battery life. In addition, some functional units can also achieve load balancing and temperature control optimization by switching connection structures, such as automatic reconfiguration of parallel or series heat dissipation circuits to ensure temperature balance of each module.

In some embodiments, the temperature equalization device includes one or a combination of the following: coated phase change material, microcapsule phase change material or composite phase change material layer, liquid cooling temperature equalization plate, microchannel cooling plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange or aerogel insulation-thermal conductive composite structure.

In some embodiments, the melting point of the phase change material can be precisely set by alloy formulation optimization or microcapsule encapsulation technology. It can also be arranged in a hierarchical array in spatial distribution, or a phase change material with multiple melting points can be deployed and combined with underground seasonal thermal energy storage (summer cold storage and winter cold release) to achieve efficient temperature control optimization across application scenarios, seasons and day and night, and reduce the energy consumption of active cooling/heating.

In some embodiments, the melting point of the phase change material can be precisely set to any of the following values (not an exhaustive list), or precisely set to any value within the range of ±2.5 °C: 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, −22.5 °C, −25 °C.

In some embodiments, the functional units of the energy storage life extension system further include a data acquisition module, which includes wired and wireless communication devices, supports multiple communication protocols including LTE, 5G, WiFi or LoRa, and uploads system operation status data and environmental data to the cloud platform in real time to realize remote monitoring, data analysis and fault diagnosis, and supports big data and AI-driven operation and maintenance management.

In some embodiments, the energy storage life extension system also supports the installation of solar shading facilities, including adjustable shading panels, shading curtains or shading canopies, to effectively reduce the heat load of the battery container; the solar shading facilities can also dynamically adjust the incident heat according to the ambient temperature, solar irradiance and battery temperature.

In some embodiments, the functional units of the energy storage life extension system further include a heat preservation system, a small reversible heat pump or an electric heating unit.

In some embodiments, the heat preservation system can quickly reduce the heat exchange efficiency of any functional unit or its components when the ambient temperature is too low, thereby avoiding the battery module temperature from being too low.

In some embodiments, the small reversible heat pump can be started for a short time under extreme low temperature conditions to return some heat energy to the battery module to prevent the battery module temperature from getting too low.

In some embodiments, the electric heating unit can be activated for a short time under extreme low temperature conditions to provide compensatory heating so that the battery module temperature is stably maintained in the life extension temperature range rather than in an overcooled state.

In some embodiments, the functional unit of the low temperature life extension module further includes a dehumidification device; the dehumidification device can be automatically activated when the battery module temperature is close to the dew point to reduce the air humidity around the battery module, thereby reducing the dew point temperature, preventing condensation on the battery surface, and ensuring the safe operation of the battery.

In some embodiments, when the ambient humidity is high and the battery module temperature is close to the dew point, the energy storage life extension system can maintain the battery module temperature at a level higher than the dew point by adjusting the heat exchange efficiency of each functional unit or component, or by activating the insulation system, small reversible heat pump or electric heating unit, thereby preventing condensation and avoiding moisture or electrical short circuit inside the battery module.

In some embodiments, the battery management system further includes the function of dynamically adjusting the charging and discharging rate of the battery module through an intelligent control algorithm based on battery state estimation (SoC), state of health estimation (SoH), temperature data and life prediction model.

In some embodiments, the battery management system not only controls charging and discharging, but also dynamically allocates the load according to the temperature, capacity and life status of each module to achieve low-temperature life extension and capacity balance; the dynamic allocation is achieved through intelligent scheduling between battery modules to avoid excessive damage to some battery modules.

In some embodiments, the battery module can automatically put some of its battery cells into a sleep or wake-up mode based on the battery health status and load prediction; the battery management system combines multi-point sensors and intelligent control algorithms to determine which modules should be put into sleep or activated in advance.

In some embodiments, the battery management system further includes the functions of fault detection, alarm and self-protection, thereby preventing overcharging, over-discharging, overheating, short circuit and imbalance.

In some embodiments, the battery management system further includes the function of: realizing data interaction with the photovoltaic inverter and the upper monitoring system through communication interfaces (such as CAN, Modbus, wireless communication) to support remote maintenance and upgrades.

In some embodiments, the battery management system further includes an optimized charge and discharge protocol for low-temperature operating range, the protocol including staged current limiting, pulse charging and depolarization pulse, to mitigate or repair charge and discharge damage under low-temperature conditions.

In some embodiments, the battery management system can combine electrochemical materials or added repair agents and current pulse strategies to locally inhibit SEI film growth or implement “dormant repair” and isolate the aging module for repair procedures during off-peak periods.

In some embodiments, the upper limit of the low-temperature working range can be selected from the following preset temperature values (the following values are only examples and not limitations), and can be adjusted within ±2.5 °C of the listed values. The selectable temperature points for the upper limit include: 35 °C, 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, and −22.5 °C.

In some embodiments, the lower limit of the low-temperature working range can also be selected from the following preset temperature values (the following values are examples), and can be adjusted within ±2.5 °C of the listed temperature points. The candidate values include: 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, −22.5 °C, and −25 °C

In some embodiments, the type of the multi-point temperature sensor includes thermocouples, thermistors (RTDs), semiconductor temperature sensors or infrared temperature sensors.

In some embodiments, multiple temperature sensors can also be arranged at different locations of the battery module to monitor the temperature distribution of each area in real time, so that the battery management system can dynamically adjust the flow rate or temperature of the fluid medium according to the temperature difference at different locations, thereby achieving targeted cooling or heat preservation and extending battery life.

In some embodiments, the functional units of the energy storage life extension system further include an environmental monitoring unit, which is equipped with a soil temperature sensor, a soil moisture sensor, an ambient temperature sensor, a relative humidity sensor, an air pressure sensor, a wind speed sensor, and a light intensity sensor.

In some embodiments, the energy storage life extension system can combine edge computing devices to analyze the data obtained by the environmental monitoring unit, calculate and adjust the temperature and flow rate of the fluid inside each pipe, ensure the efficient operation of each functional unit, and prevent excessive cooling from causing ice or condensation on the surface of the battery module.

In some embodiments, the sensors equipped in the energy storage life extension system can be connected via a wireless self-powered network. Each sensor node is powered by ambient energy (including thermoelectric power generation, wind or solar energy), eliminating the need for wiring, thereby avoiding wiring failures and improving measurement reliability and system maintainability.

In some embodiments, the surface of the photovoltaic power generation unit is provided with a nanostructure anti-reflective coating, a self-cleaning coating and a photocatalytic anti-pollution layer.

In some embodiments, the photovoltaic power generation unit may also be equipped with an inverter module with a maximum power point tracking algorithm (including but not limited to perturbation observation method, hill climbing method, and AI optimization algorithm), and may also support centralized, string and micro inverter architectures, support multiple inputs and intelligent power distribution, and ensure the highest photoelectric conversion efficiency under varying lighting conditions.

In some embodiments, the battery module is configured with a controllable power switch array, a solid-state switch, a smart contactor array, a mechanical latch, or an electrical quick connector, enabling the system to dynamically adjust the series/parallel connection mode of individual cells or battery modules; wherein, at the individual cell level, the series/parallel connection relationship of individual cells can be dynamically switched according to the temperature, internal resistance, and remaining capacity of each individual cell; the series/parallel connection relationship of battery modules can also be dynamically switched at the battery module level according to the temperature, internal resistance, and remaining capacity of each battery module.

In some embodiments, the functional unit of the energy storage life extension system further includes a power generation prediction module; the power generation prediction module can predict the power generation for a preset period of time based on weather forecast data, real-time irradiance sensor data and photovoltaic array working status, and communicate with the battery management system to input the prediction results and battery temperature distribution and remaining capacity information into the intelligent control algorithm, so as to increase the heat preservation or heat storage intensity in advance during periods of expected low power generation or low temperature environment; and prioritize the allocation of cooling and charging/discharging capacity during periods of expected high power generation or high load demand, so as to take into account both energy utilization efficiency and battery life.

In some embodiments, the battery management system establishes a digital twin model of the battery pack and accesses weather forecast data and power generation forecast data. It adopts model predictive control, reinforcement learning algorithm or other intelligent control algorithm to optimize fluid flow regulation, redundant module start-up and shutdown and charging and discharging plan in advance, so as to realize active prediction and adaptive operation strategy, so as to balance energy efficiency and battery life extension.

In some embodiments, the battery management system can also simulate and predict the impact of different temperature control strategies on the entire battery life cycle based on the digital twin model, and dynamically optimize the field control parameters accordingly to achieve a balance between long life and operating efficiency; the battery management system also includes cloud-based deployment.

In some embodiments, the functional units of the energy storage life extension system further include a system controller, which can intelligently adjust the operating status of each functional unit based on weather forecast data, load prediction, battery life optimization algorithm or other intelligent control algorithm, adjust the flow rate and temperature of the fluid medium, realize the switching between energy-saving mode and high-performance mode, and optimize the overall energy efficiency ratio of the system.

The following are fifteen of the most representative and feasible embodiments. These embodiments cover multiple aspects such as system control, thermal management, materials technology and intelligent operation and maintenance, which together constitute the core technical solution of the system.

AI Dynamic Temperature Control Prediction System Example: This system utilizes artificial intelligence and machine learning technologies to construct a dynamic temperature control system capable of accurately predicting and actively regulating battery temperature. It not only relies on real-time sensor data but also incorporates meteorological data, solar irradiance, and power generation predictions as inputs. Through deep learning algorithms, the system can predict temperature changes over the next few days and proactively activate the ground source heat pump or refrigeration equipment in the low-temperature lifespan extension module to pre-cool the fluid medium. This forward-looking prediction and proactive control ensures that the battery is in the optimal temperature control range before the temperature peak arrives, significantly reducing energy consumption.

Example of full life cycle management based on digital twin: This example proposes an energy storage life extension system based on a digital twin model to achieve refined management and optimization of the entire battery life cycle. The system establishes a high-fidelity digital twin model for each battery module, including electrochemical and thermodynamic characteristics. The data acquisition module acquires real data in real time and synchronizes it to the twin model. Combined with power generation prediction and weather forecast, it simulates and predicts the life decay under different operating strategies. Based on the prediction results, the system controller adopts intelligent algorithms such as model predictive control or reinforcement learning to dynamically adjust the temperature control and charge/discharge plan. This proactive prediction and adaptive operation strategy enables the system to achieve the best balance between long-term life and operating efficiency during long-term operation.

Example of a multi-dimensional sensor fusion and fault prediction system: The focus of this example is to utilize the fusion data of multi-dimensional sensors and, through AI-driven algorithms, to achieve fault prediction and health status diagnosis of the system. In addition to traditional sensors, the system is also equipped with internal resistance sensors, vibration sensors, acoustic sensors, and gas sensors. This multi-dimensional data is collected in real time and transmitted to the cloud platform. In the cloud, the system uses big data analysis and machine learning models to perform correlation analysis on the data. For example, by analyzing the trend of internal resistance changes and the non-uniformity of temperature distribution, the system can predict the early aging of the battery. By analyzing gas sensor data, early signs of thermal runaway can be warned. This multi-dimensional sensor fusion and AI-driven prediction system can upgrade traditional passive fault alarms to active warnings, facilitating early intervention measures.

Example of a collaborative temperature control system based on edge computing and predictive models: This example combines edge computing with predictive control algorithms. Data from the environmental monitoring unit and multi-point temperature sensors are directly transmitted to the edge computing device deployed on-site. This device has a built-in power generation prediction module, load prediction model, and battery life degradation model. Locally, the edge computing device can analyze the data in real time and use model predictive control or reinforcement learning algorithms to optimize future temperature control strategies. At the same time, the edge computing device will periodically synchronize the data to the cloud platform to achieve remote monitoring and algorithm updates, forming a collaborative working mode of “local decision-making +cloud optimization”.

Multi-mode capacity redundancy and intelligent scheduling embodiment: This embodiment focuses on the refined management of capacity redundancy function, combining hard redundancy and soft redundancy and introducing intelligent scheduling strategy. The system reserves some battery modules as “hard redundancy modules”, which remain dormant during normal operation. The battery management system (BMS) monitors the health status and temperature of all modules in real time. When a working module experiences a capacity decrease due to low temperature or aging, the BMS will dynamically activate the redundant module through a controllable power switch array to compensate for the capacity loss. At the same time, the system implements a “soft redundancy” strategy, adjusting the charging and discharging rate of the main module through intelligent algorithms to keep it in a low-load state. In the event of a sudden high power demand, the algorithm can quickly switch the module to a high-load state.

Lifetime Management and Balancing Implementation Based on “Hibernation Repair”: This implementation introduces a “hibernation repair” function to solve the problem of uneven capacity decay of battery modules in low-temperature environments, achieving dynamic balancing and lifetime extension of the battery pack. The BMS identifies modules that are aging rapidly based on the State of Health (SOH) and lifetime prediction model. During off-peak periods, the BMS isolates these modules through a smart contactor array, putting them into hibernation mode. In hibernation mode, the BMS executes specific repair procedures, such as using a current pulse strategy or adding external repair agents, to inhibit excessive SEI film growth or repair microscopic damage. After repair, the BMS reactivates the module and connects it to the main circuit. Simultaneously, to ensure performance, the system can dynamically enable capacity redundancy modules for supplementation. This “hibernation repair” strategy fundamentally alleviates the capacity and lifetime imbalance problems caused by low temperatures, achieving synergistic lifespan extension for the entire battery pack.

Example of a bidirectional heat pump and underground thermal energy storage system: This example utilizes a ground source heat pump and an underground pipeline system to construct a temperature control system capable of storing and utilizing thermal energy across seasons. In summer, a small reversible heat pump absorbs heat from the battery and transmits it deep underground for storage via the underground pipeline system. In winter, the heat pump switches to heating mode, extracts heat from underground, and returns it to the battery module to prevent excessively low temperatures. This underground seasonal thermal energy storage strategy (storing heat in summer and releasing heat in winter) greatly reduces the energy consumption of active cooling/heating. The system also incorporates phase change materials with melting points set near the low-temperature operating range as a thermal buffer. The system can also predict extreme weather in advance based on weather forecast data and intelligently adjust the heat pump operating mode and the depth of the underground pipeline to ensure that the battery is always in the optimal temperature control state.

Example of a switchable heat conduction channel and bidirectional temperature control system: This example proposes an innovative temperature control system, the core of which is a switchable heat conduction channel, designed to enable rapid switching between “strong cooling” and “heat preservation” modes to adapt to extreme hot and cold environments. In summer or high-load scenarios, the system introduces the cooling medium into the high heat conduction channel through a multi-way switching valve to achieve efficient and powerful heat dissipation. When entering winter or when the ambient temperature is too low at night, the system can automatically evacuate the cooling medium, forming an insulation layer inside the channel, thereby greatly reducing the rate of heat loss.

Example of a multi-layer thermal insulation and radiative cooling composite system: This example improves the environmental adaptability of the battery module in extreme environments through the innovative design of a multi-layer thermal insulation and heat dissipation structure. The battery box shell is made of multi-layer composite material. The outermost layer is a radiative cooling coating that reflects sunlight during the day and efficiently radiates heat into space at night. The second layer is a nano-aerogel thermal insulation composite layer that provides excellent thermal insulation performance. The third layer is a liquid-cooled heat spreader that actively absorbs heat. The bottom is filled with a phase change material with a precisely set melting point to provide thermal buffer. The system also uses a buried pipeline system to release heat underground. The pipeline adopts a telescopic structure or a multi-layer adjustable arrangement, so that the BMS can automatically select the burial depth according to the seasonal geothermal profile to maximize the use of the underground constant temperature characteristics.

Example of a superconducting thermal temperature control system with heat pipe array and steam chamber: This example utilizes efficient heat transfer technologies such as heat pipes and steam chambers to construct a pump-free, fanless, passive, and efficient temperature control system. Flat plate heat pipes are directly embedded in the cooling plate of the battery module, using a phase change heat transfer mechanism to quickly transfer heat from hot spots to heat dissipation areas. To enhance heat diffusion, a steam chamber is introduced, which can rapidly homogenize the heat generated on the surface of the battery module and eliminate local hot spots. The steam chamber is connected to the underground pipeline system via a heat exchanger, transferring heat to the fluid inside the pipeline and then releasing it underground. This passive temperature control system has extremely low energy consumption and, because it has no moving parts, extremely high reliability.

Customizable Low-Temperature Operating Range and Dynamic Adjustment System Example: The low-temperature operating range can be customized and dynamically adjusted. Users can select and adjust within a preset low-temperature operating range based on various factors such as battery chemistry, capacity, and application environment conditions. The BMS can establish a lifespan degradation model based on data such as accelerated aging tests, predict the impact of different temperature ranges on battery life, and provide users with scientific setting suggestions. The system can also dynamically adjust the specific values of the low-temperature operating range based on environmental data such as underground temperature, photovoltaic power generation, and weather forecasts. For example, when it is predicted that the temperature will continue to rise in the next few days, the system can temporarily lower the upper limit of the operating range by 2 °C.

Implementation Example of Charge/Discharge Strategy Optimization Based on Machine Learning: The focus of this embodiment is on the intelligent upgrade of the BMS, especially the use of machine learning algorithms to optimize the charge/discharge protocol to extend battery life. This algorithm learns the aging patterns of the battery under different environments by training on massive amounts of historical operating data. In low-temperature environments, the algorithm can dynamically adjust the charge/discharge rate and implement specific optimization protocols. For example, a phased current-limiting strategy can be adopted to reduce the current at the beginning and end of charging, reducing the risk of lithium deposition. Pulse charging or depolarization pulse strategies can also be used to reduce polarization, improve charging efficiency, and simultaneously reduce damage to the battery.

Example of a multi-type fluid medium and intelligent mixing system: This example proposes an innovative fluid temperature control system, the core of which lies in the on-demand switching or mixing of fluid media to cope with different environmental conditions and temperature control requirements. Multiple switchable heat conduction channels and multi-way switching valves are set in the fluid circulation pipeline. Under normal working conditions, the system uses water or ethylene glycol aqueous solution as the fluid medium. When entering an extremely cold environment, the system can automatically switch to or introduce propylene glycol aqueous solution, which has a lower freezing point, ensuring normal flow at low temperatures. When efficient heat dissipation is required, the system can achieve efficient cooling through a spray cooling device. The system is also equipped with a flow regulating valve and a control device, which can adjust the flow rate, temperature and flow path of different media in real time based on data feedback from multiple temperature sensors.

System Modularization and Rapid Assembly Retrofit Platform Implementation Example: The focus of this embodiment is on the modular installation and rapid connection design of the system, aiming to provide a flexible, scalable, and easy-to-maintain energy storage life extension solution. Each functional unit of the energy storage life extension system is designed as an independent module. Modules are rapidly assembled through quick connectors, including electrical, fluid, and signal connectors, achieving “plug and play”. When the system needs to be expanded or a module fails, maintenance personnel only need to add a new module or quickly replace it, greatly shortening downtime.

Example of thermal energy linkage between energy storage system and building HVAC system: This example aims to achieve thermal energy linkage between the energy storage life extension system and the building HVAC system, thereby realizing comprehensive energy utilization. Traditional energy storage systems generate a large amount of waste heat when dissipating heat. The system in this example uses fluid circulation pipes and heat exchangers to transport the heat generated by the battery module to the nearby building HVAC system. In winter, the use of gas boilers or electric heaters is reduced, thus reducing the building's energy consumption. In summer, cooling can be achieved through the ground source heat pump or absorption cooling equipment of the HVAC system.

The capacity redundancy function can not only compensate for the capacity loss of the battery module in the low temperature life extension range, but also further improve the life of the battery module on this basis.

Scenario 1, illustrating the effect of low-temperature life extension: At room temperature (30 °C), the nominal capacity of the battery module is 1 Ah, and the cumulative charge-discharge life is 1000 Ah, with an equivalent cycle count of 1000 cycles (1000 Ah÷1 Ah). When operating in the low-temperature life extension range of approximately 10 °C, due to the effect of low-temperature life extension, the cumulative charge-discharge life of the battery module can be extended to 3 times its original value, i.e., 3000 Ah. However, at the same time, its capacity will decrease by 15%, becoming 0.85 Ah (1 Ah×0.85).

It can be seen that although the capacity decreases by 15% due to low temperature operation, the lifespan is increased to more than three times the original, achieving a significant gain. This technical feature of “sacrificing local capacity for a multiple increase in lifespan” achieves an unexpected “leveraging effect”. In energy storage scenarios, a multiple increase in lifespan is the key to ensuring long-term operational economy.

Scenario 2 illustrates the synergistic effect of low-temperature life extension and capacity redundancy: If the battery module is further configured with capacity redundancy, and the initial capacity is increased to 1.1765 times, i.e., 1.1765 Ah, by increasing the number of cells, its cumulative charge-discharge life at room temperature is proportionally increased to 1176.5 Ah (1.1765 Ah×1000 times) due to the redundancy effect. When operating in the low-temperature life extension range of about 10 °C, although there is a 15% capacity decrease, its actual capacity can still be maintained at 1 Ah (1.1765 Ah×0.85) due to the implementation of capacity redundancy. At the same time, due to the low-temperature life extension effect, its cumulative charge-discharge life can still be increased by 3 times to 3529 Ah (1176.5 Ah×3).

As can be seen, in scenario 1, considering only the effect of low temperature life extension, the cumulative charge-discharge life is only extended by 3 times to 3000 Ah. In scenario 2, by adding 0.1765 Ah of capacity redundancy, capacity degradation can be avoided in low temperature operation scenarios, while achieving a cumulative charge-discharge life of 3529 Ah. Therefore, scenario 2 (low temperature life extension+capacity redundancy) extends the charge-discharge life by an additional 529 Ah compared to scenario 1 (low temperature life extension only), achieving a technological advancement that is “all benefits and no harm”.

In the above example, the cumulative charge and discharge amount is used as an example to illustrate the lifespan extension effect. However, in different scenarios, lifespan indicators may also include, but are not limited to: cumulative cycle count, cumulative charge amount, cumulative discharge amount, cumulative charge and discharge duration, and other parameters characterizing battery life. It should be noted that the above values and calculation results are only illustrative examples and do not limit the scope of protection of the present invention.

FIG. 2 shows the original experimental data to illustrate the low-temperature life extension effect of this case. Among them, the “Δ” symbol represents the degradation of the battery under normal temperature (30 °C) conditions. It can be observed that the initial capacity of the battery at normal temperature is relatively high, about 6.5Ah, but after about 1700 cycles, the capacity drops to about 2.5Ah, showing a clear degradation trend. In contrast, the “○” symbol represents the degradation of the battery under low temperature (15 °C) conditions. The initial capacity of the battery at low temperature is slightly lower, about 5.5 Ah, but after 3000 cycles, it can still basically maintain 5.2 Ah, and the capacity decay is almost negligible. It can be seen that although low temperature operation will cause a slight decrease in the initial capacity of the battery, in the long run, its benefit in cycle life is significantly higher than that under normal temperature conditions. On the other hand, in the normal temperature scenario, although the battery capacity is slightly higher than that in the low temperature scenario in the early stage of degradation (between 0~250 cycles), there is a local capacity advantage, but its overall life is significantly worse than that of the battery under low temperature conditions. In current new energy storage applications, the significant extension of battery life is a key factor determining the long-term economic viability of operation. Therefore, the long-term advantages brought by low-temperature life extension are particularly important.

Optionally, the battery module can be constructed into a composite structure through various arrangements, including stacking, layering, honeycomb, grid, ring, matrix, or three-dimensional arrangement, to meet the energy capacity, power output, and space utilization efficiency requirements of different applications. The battery module can be designed as a flexible array, foldable structure, or modular splicing form to adapt to the installation environment of space-constrained or scalable equipment. The geometry of the battery module may include cylindrical, square, rectangular, flat sheet, stacked sheet, ring, elliptical, polygonal, prism, triangular, rollable flexible sheet, or a modular geometric structure formed by combining several battery cells, thereby achieving flexible combination and assembly.

Optionally, the battery module packaging form includes, but is not limited to, metal shell, plastic shell, composite material shell, soft pack, modular shell, waterproof and dustproof seal, enhanced heat dissipation structure, embedded packaging or surface coating, to provide environmental protection, thermal management and mechanical strength.

Optionally, the battery module may be a variety of electrochemical devices suitable for energy storage and energy release, including but not limited to lithium batteries (such as lithium-ion, lithium iron phosphate, ternary materials, lithium sulfur, polymer lithium batteries), sodium batteries, aluminum batteries, magnesium and its ion batteries, graphene batteries, sulfur batteries, nickel-metal hydride batteries, lead-acid batteries, all-solid-state batteries, solid-liquid hybrid batteries, metal and metal-ion batteries, air batteries, fuel cells, halide batteries, silicon-based batteries and supercapacitors.

Optionally, a phase change material may be provided at the bottom of the battery box or at its junction with the underground pipeline, and a radiation cooling coating may be applied to the outer surface of the box to achieve thermal buffering by utilizing the day-night and seasonal temperature differences and to improve passive heat dissipation efficiency. The structure of the heat exchanger includes plate type, shell-and-tube type or finned tube type structure. The burial method of the underground pipeline system includes horizontal burial, vertical burial or composite three-dimensional burial, so as to flexibly adjust according to soil type, climate conditions and system scale, and utilize the stable low temperature environment underground to improve cooling efficiency.

Optionally, the buried pipeline system adopts a scalable structure or a multi-layer adjustable arrangement with injectable/extractable burial depth, so that its burial depth and horizontal distribution can be flexibly adjusted and automatically switched to different heat collection/heat dissipation sections according to the season, day and night ground temperature profile and geological conditions, thereby achieving the best coupling with the underground stable temperature, improving heat exchange efficiency and temperature control accuracy, keeping the battery module temperature stably maintained in the low temperature working range, and enhancing the system's adaptability and energy efficiency in different regions and seasons.

Optionally, the burial depth of the underground pipeline system can be arbitrarily selected from the following values (not an exhaustive list): 0 meters, 50 meters, 100 meters, 200 meters, 500 meters, 1000 meters, 2000 meters, 3000 meters, and the burial depth can also be selected within the range corresponding to the above values, which can be ±100 meters based on the value, or ±50% based on the value.

Optionally, the applicable pipeline structure in the energy storage life extension system includes, but is not limited to, solid metal pipelines, hollow fluid pipelines, or composite structures; the applicable pipeline layout in the energy storage life extension system includes, but is not limited to, serpentine, spiral, grid, radial, multi-layer superimposed, horizontal, vertical drilling, oblique burial, and multi-layer composite burial structures; the pipeline is also equipped with a fluid quick connector to support rapid on-site assembly, maintenance, expansion, and functional upgrade of the pipeline.

Optionally, the surface of the pipe may be coated with a special coating to improve thermal conductivity and corrosion resistance, and the heat exchange efficiency may be further improved by filling with thermally conductive materials (such as bentonite or thermally conductive mortar) between it and other heat exchange objects.

Optionally, the outer shell material of the battery module may be selected from any one or more combinations of the following materials: aluminum alloy, copper, stainless steel, carbon steel (with anti-corrosion treatment), titanium alloy, magnesium alloy, polyethylene, cross-linked polyethylene, polyurethane foam tube, polypropylene, polyvinylidene fluoride, polytetrafluoroethylene, chlorinated polyvinyl chloride, high thermal conductivity plastics (such as graphite-filled polypropylene, thermally conductive nylon, carbon fiber reinforced PEEK), glass fiber reinforced plastics, carbon fiber reinforced materials, aramid fiber composite materials, metal-ceramic composite tubes, high thermal conductivity concrete-coated tubes, ceramic tubes, ceramic coating materials (including alumina ceramics, silicon nitride ceramics or metal-ceramic composite coatings), and nano-modified materials (such as graphene composite materials, carbon nanotube composite polymers, nano-aerogel thermal insulation composite layers).

Optionally, the fluid medium that may be equipped in the energy storage life extension system includes, but is not limited to: water, deionized water, ethylene glycol aqueous solution, propylene glycol aqueous solution, liquid nitrogen, liquid helium, environmentally friendly Freon refrigerant, compressed air, nitrogen, organic solvent, inorganic solvent, natural refrigerant (such as carbon dioxide, ammonia) or compressed air.

Optionally, the battery status that the battery management system can monitor includes, but is not limited to, voltage, current, temperature, SOC (state of charge), SOH (state of health), internal resistance, power, capacity decay, number of charge and discharge cycles, balance status of individual cells or modules, temperature distribution, electrolyte status, electrode status, and safety status (such as overcharge, over-discharge, short circuit, over-temperature, over-voltage, under-voltage, and overcurrent alarms); the charge and discharge control functions implemented by the battery management system include, but are not limited to, constant current and constant voltage charge and discharge, power control, equalization control, thermal management linkage control, and abnormal protection control.

This design, through its highly modular and diverse battery module structure, combined with various materials and packaging forms, multiple fluid media, pipeline structures, and quick connection design, adapts to different installation environments and application requirements. The underground pipeline system, combined with various high thermal conductivity materials and adjustable burial methods, achieves efficient underground heat exchange and precise temperature control.

The embodiments of the present invention are merely illustrative and should not be considered as limitations on the scope of protection of the present invention. Those skilled in the art, after understanding the principles and technical ideas of the present invention, can modify, improve, optimize, replace, or extend the embodiments without departing from the spirit and essence of the present invention, including but not limited to functional module reorganization, sequence adjustment, system expansion, parameter optimization, algorithm replacement, or implementation method change. Technical features in different embodiments can be arbitrarily combined or cross-referenced without causing contradictions. Their combination methods, equivalent variations, improvement schemes, replacement schemes, and schemes that achieve the same function through different structures, methods, or processes should all be considered part of the scope of protection of the claims of the present invention. The present invention can be applied to various scenarios or system environments, and its technical solutions can achieve the expected effects and ensure the reliability and economy of the system functions. The scope of protection of the present invention is determined by the claims. Any modifications, replacements, combinations, equivalent effects, or equivalent implementations falling within the scope of the claims should be included within the scope of protection of the present invention.

The technical solution of the present invention can be implemented alone or in combination with other energy storage management strategies, energy dispatching methods or temperature control devices. Although the specification describes solutions such as low-temperature life extension control, heat dissipation structure and intelligent management in conjunction with specific embodiments, its core lies in “extending battery life and reducing heat dissipation energy consumption by utilizing the low-temperature environment ”. Any equivalent solution that can achieve this core objective should be considered to fall within the protection scope of the present invention. The present invention is not only applicable to solar energy storage stations, but can also be extended to various application scenarios such as distributed photovoltaics, home energy storage, microgrids, photovoltaic charging facilities and industrial and commercial peak shaving and valley filling.

This invention has significant industrial application value and promotion prospects. First, by adopting underground pipe cooling technology, precise control of battery temperature is achieved, ensuring that the lithium battery operates within the low-temperature working range, maximizing the delay of battery aging, and significantly improving the overall lifespan and reliability of the energy storage system. Second, this solution makes full use of natural underground low-temperature resources, reducing the energy consumption of traditional heating and active cooling devices, lowering system operating costs, and improving the economic benefits of photovoltaic energy storage stations, especially suitable for large-scale, long-cycle distributed energy storage projects. In addition, the modular energy storage unit and temperature control system designed in this invention support flexible engineering deployment and maintenance, facilitate rapid on-site installation and expansion, adapt to various photovoltaic scenarios (such as photovoltaic power stations, industrial and commercial rooftops, agricultural photovoltaics, etc.), and greatly improve engineering implementation efficiency. Finally, through intelligent temperature monitoring and management, the system can dynamically adjust the temperature control strategy in real time to ensure safe battery operation, effectively reduce the risk of thermal runaway, improve the safety level of the energy storage system, and comply with the strict safety standards of industrial production. In summary, this invention not only possesses significant energy-saving, emission-reduction, and economic benefits, but also, due to its high reliability and ease of maintenance, has great potential for industrial application, providing a solid technical guarantee for promoting the development of green energy and smart grids.

1. An energy storage life extension system for solar power generation, characterized in that:
Includes functional units: battery module, photovoltaic power generation unit, battery management system, and low-temperature life extension module;
The battery module is composed of multiple individual battery cells connected in series and/or in parallel, and multiple battery modules can also be connected in series and/or in parallel to form a battery cluster;
The photovoltaic power generation unit is electrically connected to the battery module, which can convert solar energy into electrical energy and charge the battery module;
The functions of the battery management system include: real-time monitoring and data acquisition of the operating parameters of the battery module;
The low-temperature life extension module is used to maintain the temperature of the battery module within the low-temperature operating range, so as to extend the battery life through active cooling, rather than just preventing the battery from overheating or thermal runaway;
The low-temperature operating range is a low-temperature range that is below room temperature but above the dew point;
While the battery module can have its lifespan extended when used in the low-temperature operating range, its capacity will be reduced due to the decrease in the electrochemical reaction rate;
Each functional unit, subsystem, subcomponent or device in the energy storage life extension system is optional; The electrical-related parts have a sealed structure to suppress low-temperature condensation and improve adaptability in low-temperature scenarios;
The operating parameters include, but are not limited to: voltage, current, power, temperature, and other parameters that can characterize the battery's operating performance, safety, and lifespan; and are applicable to both battery modules and individual cells or battery clusters.

2. The energy storage life extension system for solar power generation as described in claim 1, characterized in that:
The energy storage life extension system, or its functional units, subsystems, subcomponents or devices, may be equipped with a temperature equalization device to ensure uniform temperature distribution and avoid the generation of local hot spots;
The battery management system also includes the function of constraining and controlling the operating parameters of the battery module to keep them below a preset threshold during charging and discharging, thereby preventing the battery module from experiencing increased side reactions under adverse operating conditions;
The battery module is also equipped with a capacity redundancy function; the capacity redundancy function compensates for the capacity loss caused by low temperature by pre-configuring additional capacity for the battery module, ensuring that the battery module can meet the external power grid connection requirements at any time; wherein, the capacity redundancy function is an optional configuration;
The low-temperature life extension module can adopt any active or passive temperature control measures as needed, or combine multiple methods, and/or combine structural optimization, cooling channel design and intelligent temperature control algorithm, so that the battery module can be maintained in the low-temperature operating range under different working conditions;
The active temperature control measures include air cooling, liquid cooling, spray cooling, immersion liquid cooling, thermoelectric refrigeration, refrigerant compression cycle, and heat pump system; These measures can dynamically and precisely adjust heat dissipation efficiency or temperature control intensity based on real-time temperature changes to achieve rapid cooling and precise temperature control; The passive temperature control measures include natural convection heat dissipation, thermally conductive materials and heat sinks, phase change material heat absorption, evaporative cooling, heat pipes and loop heat pipes, heat spreaders, and insulation and heat preservation structures, which can effectively reduce heat dissipation energy consumption;
The energy storage life extension system itself, or its various functional units, subsystems, sub-components or sub-devices, can all be regarded as modularly installed external units; They can be quickly assembled, disassembled, maintained, expanded and upgraded through quick connectors; They can also be configured according to actual temperature control requirements and support on-site modification and upgrading of existing energy storage battery containers without changing their inherent waterproof and dustproof structure.

3. The energy storage life extension system for solar power generation as described in claim 2, characterized in that:
The battery module's housing structure can be designed as a multi-layered heat insulation and heat dissipation structure, which can enhance environmental adaptability and is suitable for high humidity, high salt spray and strong ultraviolet radiation environments;
The operating parameters also include current change rate, voltage change rate, temperature distribution, temperature rise rate, state of charge, health status, number of cycles, depth of discharge, internal resistance, impedance, polarization voltage, open circuit voltage vs; SOC deviation, side reaction related indicators, insulation status, leakage current, short circuit characteristic parameters, pressure or gas concentration, and mechanical stress parameters;
The low-temperature life extension module can employ passive heat dissipation temperature control measures;
When the integrated control module detects that one or more operating parameters are close to or exceed the preset threshold, it will activate the corresponding protection strategy; The protection strategy may include, but is not limited to: reducing the charging current, reducing the discharging current, reducing the charging and discharging power or voltage, performing circuit disconnection operation, and/or outputting alarm prompts;
The functional units of the low-temperature life extension module also include a heat exchanger and a fluid circulation pipeline;
The photovoltaic power generation unit can also be replaced with a wind power generation unit, thus enabling flexible application to wind power generation scenarios and achieving efficient conversion and storage of wind energy;
The specific implementation of the capacity redundancy function of the battery module includes hard redundancy and soft redundancy;
The hard redundancy is achieved by configuring a certain proportion of redundant battery cells; The battery module can monitor the external power grid connection demand in real time; When the external power grid connection demand exceeds the capacity of the battery module, the battery module can control the activation of the redundant battery cells and use them in conjunction with the battery module itself, thereby ensuring that the total capacity of the battery module and the redundant battery cells can meet the external power grid connection demand;
The soft redundancy is achieved by pre-setting the total capacity of the battery module to be higher than the required power grid connection demand by a certain percentage during the initial design phase of the battery module; The battery module is kept in a low-load state during normal operation, and when the external power grid connection demand increases significantly, the battery module can be automatically switched to a high-load state through intelligent control algorithms to ensure that the overall capacity of the battery module meets the external power grid connection demand.

4. The energy storage life extension system for solar power generation as described in claim 3, characterized in that:
The functional units of the energy storage life extension system also include safety protection devices, whose functions include, but are not limited to: multi-level over-temperature protection, overcharge and over-discharge protection, short circuit protection, insulation detection, thermal runaway suppression, fire alarm and automatic power-off;
The heat exchanger is in direct contact or indirectly connected to the battery module and is used to absorb the heat generated by the battery module;
The heat exchanger is in direct contact or indirectly connected to the fluid circulation pipe, thereby transferring heat to the fluid circulation pipe; The fluid circulation pipe is also equipped with a fluid medium circulating inside to improve heat exchange efficiency;
The fluid circulation pipe can transfer the absorbed heat to the outside or to other heat dissipation components to achieve effective heat dissipation of the battery module;
The low-temperature life extension module is also equipped with a refrigeration device;
The refrigeration device can be directly or indirectly connected to the energy storage life extension system itself or its various functional units, subsystems, sub-components or sub-devices through a pipeline system to achieve forced heat dissipation; When the passive heat dissipation capacity of the low-temperature life extension module is insufficient to keep the battery module in the low-temperature operating range, the refrigeration device can be activated to provide additional cooling capacity to ensure that the battery module is kept in the low-temperature operating range;
The low-temperature life extension module can also predict underground temperature, weather changes, and power generation of the power generation unit, and automatically adjust heat dissipation or cooling strategies to ensure that the battery module is maintained in the low-temperature operating range;
The specific range of values for the low-temperature operating range will vary depending on various factors, including the battery chemistry system, capacity, rated operating voltage, and specific application environment conditions;
The determination of the low-temperature operating range can be achieved through various methods, including laboratory tests, bench tests, or comprehensive analysis;
These methods may include, but are not limited to, using multi-temperature, multi-cell cycle life tests, accelerated degradation tests, and thermal characteristic studies to evaluate the battery's capacity decay, lifespan changes, and safety performance under low-temperature conditions, thereby determining its applicable low-temperature operating range; Alternatively, it can be selected based on practical experience and the parameter range provided by the manufacturer, or predicted by combining battery thermal management models, lifespan degradation models, and kinetic simulation methods; In addition, it can be determined by using historical operating data for statistical modeling or through multi-parameter coupling optimization.

5. The energy storage life extension system for solar power generation as described in claim 4, characterized in that:
The functional units of the low-temperature life extension module also include a buried pipeline system;
The fluid circulation pipeline is directly or indirectly connected to the underground pipeline system, thereby transferring heat to the underground pipeline system and releasing the heat underground or introducing it into other low-temperature cold sources through the underground pipeline system;
The flow of the fluid medium is driven by an electric pump, magnetic pump, compressor or gravity; The low temperature life extension module can be equipped with a multi-way switching valve, flow regulating valve, temperature sensor and control device as needed to automatically adjust the fluid flow rate, temperature and flow path according to the battery temperature to achieve dynamic control of the required temperature;
The battery module can be divided into several thermal management zones; Each zone is equipped with an independent fluid circulation pipeline and a flow regulator to achieve independent and precise control of the temperature of each zone and to stably maintain the temperature of each zone within the low-temperature operating range;
The fluid medium is switched or mixed as needed during operation to adapt to different environmental conditions and optimize heat exchange efficiency and energy consumption;
All the pipes in the low-temperature life extension module are switchable; A heat transfer medium with a high thermal conductivity can be injected when needed, or an insulation layer can be formed by evacuation, so as to realize the rapid switching of the system between “strong cooling” and “heat preservation” modes;
Each functional unit, subsystem, subcomponent, or subdevice in the energy storage life extension system can be equipped with a multi-point temperature sensor, and the collected temperature information can be fed back to the intelligent control algorithm in real time to ensure that the battery module is maintained in the low-temperature operating range;
The energy storage life extension system can dynamically adjust the execution order, operating mode, operating parameters and operating intensity of each functional unit or component according to the environmental conditions and load requirements of the battery module, so as to achieve adaptive frequency conversion control, or reconstruct or switch the topological connection structure of each functional unit or component as needed, to ensure that the battery module is maintained in the low temperature operating range.

6. The energy storage life extension system for solar power generation as described in claim 5, characterized in that:
The temperature equalization device includes one or a combination of the following:
coated phase change material, microcapsule phase change material or composite phase change material layer, liquid cooling temperature equalization plate, microchannel cooling plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange or aerogel insulation-thermal conductive composite structure;
The melting point of the phase change material can be precisely set by optimizing the alloy formula or using microcapsule encapsulation technology; It can also be arranged in a hierarchical array in spatial distribution, or a variety of phase change materials with different melting points can be deployed and combined with underground seasonal thermal energy storage (summer cold storage and winter cold release) to achieve efficient temperature control optimization across application scenarios, seasons, and day and night, thereby reducing the energy consumption of active cooling/heating;
The melting point of the phase change material can be precisely set to any of the following values (not an exhaustive list), or precisely set to any value within ±2.5 °C of the following values: 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, −22.5 °C, −25 °C;
The functional units of the energy storage life extension system also include a data acquisition module, which includes wired and wireless communication devices that support multiple communication protocols including LTE, 5G, WiFi or LoRa; The system uploads system operation status data and environmental data to the cloud platform in real time to achieve remote monitoring, data analysis and fault diagnosis, and support big data and AI-driven operation and maintenance management;
The energy storage life extension system also supports the installation of solar shading facilities, including adjustable sunshades, sun curtains or sun awnings, to effectively reduce the heat load on the battery container; the solar shading facilities can also dynamically adjust the incident heat according to the ambient temperature, solar irradiance and battery temperature;
The functional units of the energy storage life extension system also include a thermal insulation system, a small reversible heat pump, or an electric heating unit;
When the ambient temperature is too low, the insulation system can quickly reduce the heat exchange efficiency of any functional unit or its components, thereby preventing the battery module temperature from getting too low;
The small reversible heat pump can be started briefly under extreme low temperature conditions to return some heat energy to the battery module to prevent the battery module temperature from getting too low;
The electric heating unit can be activated briefly under extreme low temperature conditions to provide compensatory heating, so that the battery module temperature is stably maintained in the extended life temperature range rather than in an overcooled state.

7. The energy storage life extension system for solar power generation as described in claim 6, characterized in that:
The fluid circulation pipeline can also recover and utilize some of the heat according to actual needs, thereby improving the overall energy utilization efficiency;
The functional unit of the low-temperature life extension module also includes a dehumidification device; the dehumidification device can automatically start when the battery module temperature is close to the dew point to reduce the air humidity around the battery module, thereby lowering the dew point temperature, preventing condensation on the battery surface, and ensuring the safe operation of the battery;
When the ambient humidity is high and the battery module temperature is close to the dew point, the energy storage life extension system can maintain the battery module temperature above the dew point by adjusting the heat exchange efficiency of each functional unit or component, or by activating the insulation system, small reversible heat pump or electric heating unit, thereby preventing condensation and avoiding moisture inside the battery module or electrical short circuit;
The battery management system also includes the following functions: dynamically adjusting the charging and discharging rate of the battery module based on battery state estimation (SoC), state of health estimation (SoH), temperature data, and life prediction model through intelligent control algorithms;
The battery management system not only controls charging and discharging, but also dynamically allocates the load according to the temperature, capacity and lifespan of each module to achieve low-temperature life extension and capacity balance; the dynamic allocation is achieved through intelligent scheduling between battery modules to avoid excessive damage to some battery modules;
The battery module can automatically put some of its battery cells into sleep or wake-up mode based on battery health status and load prediction; the battery management system combines multi-point sensors and intelligent control algorithms to determine which modules should be put into sleep or activated in advance;
The battery management system also includes functions such as fault detection, alarm and self-protection to prevent overcharging, over-discharging, overheating, short circuit and imbalance;
The battery management system also includes the following functions: enabling data interaction with the photovoltaic inverter and the upper-level monitoring system through communication interfaces (such as CAN, Modbus, and wireless communication), and supporting remote maintenance and upgrades.

8. The energy storage life extension system for solar power generation as described in claim 7, characterized in that:
The battery management system also includes an optimized charge and discharge protocol for the low-temperature operating range, which includes staged current limiting, pulse charging, and depolarization pulses to mitigate or repair charge and discharge damage under low-temperature conditions;
The battery management system can combine electrochemical materials or external repair agents and current pulse strategies to locally inhibit SEI film growth or implement “dormant repair” and isolate the aging module for repair during off-peak periods;
The upper limit of the low-temperature operating range can be selected from the following preset temperature values (the following values are for illustrative purposes only and not limitations), and can be adjusted within ±2.5 °C of the listed values; The selectable temperature points for the upper limit include: 35 °C, 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, and −22.5 °C;
The lower limit of the low-temperature operating range can also be selected from the following preset temperature values (the following values are examples), and can be adjusted within ±2.5 °C of the listed temperature points; The candidate values include: 30 °C, 25 °C, 22.5 °C, 20 °C, 17.5 °C, 15 °C, 12.5 °C, 10 °C, 7.5 °C, 5 °C, 2.5 °C, 0 °C, −2.5 °C, −5 °C, −7.5 °C, −10 °C, −12.5 °C, −15 °C, −17.5 °C, −20 °C, −22.5 °C, −25 °C;
The types of multi-point temperature sensors include thermocouples, thermistors (RTDs), semiconductor temperature sensors, or infrared temperature sensors;
Multiple temperature sensors can also be arranged at different locations of the battery module to monitor the temperature distribution of each area in real time; This allows the battery management system to dynamically adjust the flow rate or temperature of the fluid medium according to the temperature differences at different locations, thereby achieving targeted cooling or heat preservation and extending battery life;
The functional units of the energy storage life extension system also include an environmental monitoring unit, which is equipped with a soil temperature sensor, a soil moisture sensor, an ambient temperature sensor, a relative humidity sensor, an air pressure sensor, a wind speed sensor, and a light intensity sensor.

9. The energy storage life extension system for solar power generation as described in claim 8, characterized in that:
The energy storage life extension system can combine edge computing devices to analyze the data obtained by the environmental monitoring unit, calculate and adjust the temperature and flow rate of the fluid inside each pipe, ensure the efficient operation of each functional unit, and prevent excessive cooling that could cause ice or condensation on the surface of the battery module;
The sensors in the energy storage life extension system can be connected via a wireless self-powered network; Each sensor node is powered by ambient energy (including thermoelectric power generation, wind or solar energy), eliminating the need for wiring, thereby avoiding wiring failures and improving measurement reliability and system maintainability;
The surface of the photovoltaic power generation unit is provided with a nanostructured anti-reflective coating, a self-cleaning coating, and a photocatalytic anti-pollution layer;
The photovoltaic power generation unit can also be equipped with an inverter module with a maximum power point tracking algorithm (including but not limited to perturbation observation method, hill climbing method, and AI optimization algorithm), and can also support centralized, string and micro inverter architectures, support multiple inputs and intelligent power distribution, and ensure the highest photoelectric conversion efficiency under varying lighting conditions;
The battery module is equipped with a controllable power switch array, solid-state switch, intelligent contactor array, mechanical latch, or electrical quick connector, enabling the system to dynamically adjust the series/parallel connection mode of individual cells or battery modules; At the individual cell level, the series/parallel connection of individual cells can be dynamically switched based on their temperature, internal resistance, and remaining capacity; Similarly, at the battery module level, the series/parallel connection of battery modules can be dynamically switched based on their temperature, internal resistance, and remaining capacity.

10. The energy storage life extension system for solar power generation as described in claim 9, characterized in that:
The functional units of the energy storage life extension system also include a power generation prediction module; The power generation prediction module can predict the power generation for a preset period based on weather forecast data, real-time irradiance sensor data, and the working status of the photovoltaic array; It communicates with the battery management system and inputs the prediction results, battery temperature distribution, and remaining capacity information into the intelligent control algorithm;
This allows the system to increase insulation or heat storage intensity in advance during periods of expected low power generation or low temperature; During periods of expected high power generation or high load demand, the system prioritizes the allocation of cooling and charging/discharging capacity to balance energy utilization efficiency and battery life;
The battery management system establishes a digital twin model of the battery pack and integrates weather forecast data and power generation forecast data; It adopts model predictive control, reinforcement learning algorithms or other intelligent control algorithms to optimize fluid flow regulation, redundant module start-up and shutdown and charging and discharging plans in advance, so as to realize active prediction and adaptive operation strategies to balance energy efficiency and battery life extension;
The battery management system can also simulate and predict the impact of different temperature control strategies on the entire battery life cycle based on the digital twin model, and dynamically optimize the field control parameters accordingly to achieve a balance between long life and operating efficiency; the battery management system also includes cloud-based deployment;
The functional units of the energy storage life extension system also include a system controller, which can intelligently adjust the operating status of each functional unit based on weather forecast data, load prediction, battery life optimization algorithms or other intelligent control algorithms, adjust the flow rate and temperature of the fluid medium, realize the switching between energy-saving mode and high-performance mode, and optimize the overall energy efficiency ratio of the system.
